(19) United States
(12) Patent Application Publication
(10) Pub. No.: US 2017/0148046 A1
(43) Pub. Date: May 25, 2017

(54) SYSTEM AND METHOD FOR CONSUMER MANAGEMENT PURCHASING AND ACCOUNT INFORMATION

(71) Applicant: MAVATAR TECHNOLOGIES, INC., Menlo Park, CA (US)

(72) Inventors: Susan Zahra AKBARPOUR MASHADI, Atherton, CA (US); Brian Bahram MAHBOD, Los Altos Hills, CA (US); Panagiotis PAPADIMITRIOU, Mountain View, CA (US)

(21) Appl. No.: 15/339,181

(22) Filed: Oct. 31, 2016

Related U.S. Application Data
(63) Continuation of application No. 13/436,783, filed on Mar. 30, 2012, now abandoned.
(60) Provisional application No. 61/470,289, filed on Mar. 31, 2011.

(51) Int. Cl. G06Q 30/02; G06Q 30/06

(52) U.S. Cl. CPC G06Q 30/0239; G06Q 30/0629; G06Q 30/0633; G06Q 30/0643

(57) ABSTRACT

Disclosed is a method and system that facilitates a platform for online purchasing and account management comprising: a universal shopping cart component, a social networking marketplace, identity and profile management, and a privacy patrol component. The method and system provides the ability to automatically optimize a user's shopping experience.

### CROSS-REFERENCE TO RELATED APPLICATIONS:

This present application is a continuation application of U.S. application Ser. No. 13/436,783 entitled, “SYSTEM AND METHOD FOR CONSUMER MANAGEMENT PURCHASING AND ACCOUNT INFORMATION”, filed on Mar. 30, 2012 and which claims the benefit of priority under 35 U.S.C. 119(e) to the filing date of U.S. Provisional Application 61/470,289 entitled, “SYSTEM FOR CONSUMER MANAGEMENT OF ONLINE PURCHASING AND ACCOUNT INFORMATION” which was filed on Mar. 31, 2011, and which is incorporated herein by reference in its entirety.

### FIELD OF THE INVENTION

This invention relates to electronic commerce, and more specifically, to a method and system for providing an aggregated and optimized interface for retail purchasing solutions. In particular, the present invention is a user-centric and merchant independent method and system for managing online purchasing and account information while also providing privacy protection to the users.

### BACKGROUND OF THE INVENTION

Over the last several years, the Internet has seen expansive growth in the area of electronic commerce (“e-commerce”). Today, many consumers shop over the Internet from electronic retailers (“merchants”) in the privacy of their homes instead of shopping from catalogs or physically going to a store. While a consumer may not be able to physically handle the products while shopping on the Internet, she may be able to view pictures of the products, have textual, graphical and audio descriptions of the products, as well as read reviews of the products. For example, a merchant may create an e-commerce site on the World Wide Web (the “Web” or “WWW”) that is devoted to products carried in a physical store. This product information is typically made accessible to a consumer over the Internet through Web pages created by the merchant. A problem with this approach is that consumers have to learn how to navigate through all of the different e-commerce sites where they are interested in shopping. Furthermore, it is also very cumbersome for consumers to have to keep track of the different sales, promotions, rewards, coupons, gift cards, store credits, loyalty programs, etc. of all these different e-commerce sites (collectively referred as value elements herein). It would therefore be desirable to have an agnostic and user centric shopping cart and/or e-commerce site where the consumer navigates and shops in the same manner regardless of the merchants from which the consumer is shopping in order to receive personalized deals base on her life time value at different retailers.

If the consumer locates a product in which he or she is interested, the consumer is typically allowed to purchase the product(s) at that time. For example, if the consumer is interested in purchasing product A from a merchant, the consumer will provide appropriate information to the merchant over a secure connection in order to process the order. This information typically includes name, shipping address, billing address, payment information and desired shipping method. This information is typically entered through an input form on a Web page designed and provided by the merchant. It is also common for the merchant to require the consumer to create an account on the site of said merchant before purchasing products. If a consumer purchases products from many different sites, he or she will have to keep track of the many different accounts. It is desirable, therefore, to have a shopping facility that enables a consumer to order products from many different merchants without requiring the consumer to keep track of all the different accounts and shopping history required to purchase goods from these merchants.

Another e-commerce related problem is that it is becoming more difficult for a consumer to locate products, services, and comparison shop over the internet. This is due to the sheer volume of merchants, products, and services available to the consumer over the Internet. Today, a consumer may also use one of the commonly available search engines on the Internet to locate products. However, search engines generally return so many matches to a query that it is unrealistic for a consumer to manually inquire on each returned match. In addition, these matches also include both merchant and non-merchant Web sites making it even more difficult for a consumer to actually review all of the returned merchant sites.

As e-commerce has developed, the term “shopping basket” or “shopping cart” has become commonly known on the Internet to refer to a virtual shopping cart where the consumer stores the products and/or services he/she is interested in purchasing while browsing a particular merchant's Web site. A shopping cart typically allows a consumer to add or delete products, specify attributes such as color, quantity, size, and purchase products contained in the cart. Once the consumer has completed his/her product(s) selection, he/she typically clicks on a link on one of the merchant's Web pages to purchase the contents of the shopping basket. A problem with the shopping carts, however is that they are specific to each merchant. Another problem is that majority of the shopping carts do not allow a consumer to keep products not purchased in their shopping cart from one visit to the next shopping site. It would be desirable, therefore, to have a capability within the shopping cart that would maintain the un-purchased items in the cart persistently and across multiple merchants until the consumer decides to delete or purchase the product.

Accordingly, a method and system for a day-to-day utility is needed that provides a consumer with a uniform ordering and navigation tool through multiple merchants. The method and system should enable the consumer to order products from multiple merchants. In addition, the method and system should provide the consumer with a consistent look and feel regardless of the merchant from whom the consumer is ordering products. The present invention solves these problems as well as others presented by the prior art.

Another often encountered issue is the use of incentives to drive the sale of goods. In commercial industries many marketing techniques include the use of coupons, manufacturer's rebates, and promotional discounts, among others (collectively referred to as “Value Elements” or “VE”). For purposes of this application, VEs include not only coupons and discount media, but also manufacturer's or other rebates and certificates, loyalty points, gift cards, store credits, discounts due to sales promotions, and the like. VEs are an effective marketing scheme used to drive customers to purchase the products being promoted. VEs can be for a specific store or for a specific item. Challenges for the use of coupons (VE) can be broken into three areas: (1) delivery, (2) organization, and (3) redemption.

Paper coupons are a traditional method of increasing sales and attracting new consumers. These paper coupons have traditionally been delivered to consumers through printed media such as newspaper, magazine mailing, or through direct mail marketing or other similar delivery systems. Delivery of printed-paper coupon is expensive for the marketer, and it is difficult for the marketer to narrowly target the paper coupons to those most likely to use them given the typical breadth of traditional printed media and direct mail lists. In addition to incurring the cost of printing and delivering the offer, the marketer incurs the cost of training personnel to accept the offer at the Point of Sale (“POS”), the time it takes the personnel to input the coupon at the POS, the cost to store the paper offer, and the cost to audit the offer. Additionally, there is a fraud cost associated with the use of paper coupons.

The consumer clips or selects the paper coupons upon receiving them. As far as the consumer is concerned, organizing paper coupons is difficult and time-consuming. Consumers often place their paper coupons in a drawer or other unorganized receptacle. The coupons oftentimes, are left in a drawer at home, unredeemed and ultimately expire, unused. The consumers often fail to even remember that they have coupons that can be applied to their purchases. Further, consumers may forget to take their coupons with them to the store or may not have the coupons with them for other reasons. In sum, paper coupons are difficult for the consumer to keep track of, organize, and redeem at the POS.

As online marketing becomes increasingly common, online marketers are readily able to rent or buy lists from list owners, and send, through mass e-mailings, e-mail offers to the thousands of consumers on the owner's list. Paperless coupons delivered through these methods and system can be redeemed at online merchants without the necessity of printing them, such as by delivering a coupon code electronically and having the consumer manually input the code at the online payment page. For brick-and-mortar merchants, however, the consumer is often still left with the classic problem of having to create and use paper coupons, such as by printing out the electronically delivered coupon offers. Thus, consumers are again confronted with the organizational and redemption issues associated with paper coupons. Further to the above approaches, although marketers have avoided the costs of printing and delivery of the offers, the marketers still face significant costs associated with fraud and fraud detection, auditing of the coupons, and with training of personnel at the POS. Accordingly, it will be desirable for the marketers to be able to electronically deliver coupon offers as it decreases the cost of marketing as well as instances of fraud.

Moreover, there has been a surge of personalized coupons (and in general, personalized VEs) as opposed to public coupons. A public coupon may be defined as a coupon that is made available to everyone while a personalized coupon that can be generated for a particular person or persons may be used as a tool to attract users and trigger sales if it matched perfectly to the needs, profile and the life time value of the consumer to the merchant. For example, retailers are often more likely to see a larger increase in sales if they can offer a customer $100 off the purchase of an Apple Macbook Air because they know that she is in the market for that specific product, rather than offering a $50 off any purchase over $800 to everyone on the mailing list or to the general public at large. As such, personalized coupons specifically targeted at particular groups of customers to address their specific needs are often more effective, less costly, and thus on the rise. Accordingly, it will be desirable to have a method and system that provide personalized coupon to consumers with offers that specifically target consumers who may be interested in the marketed products, as it is more cost-effective and does not diminish the brand's power or image.

In the case of manufacturer's rebates, the customer typically receives a certificate at the time of purchase that requires her to fill in certain information such as address, phone number, e-mail address, and sometimes other information related to the interests of the customer. Manufacturer's rebates also usually include space for providing information about the item or product purchased. This information may sometimes include model number, serial number, the name of the product, the store at which the product was purchased, etc.

While such coupon-related marketing techniques typically increase sales, customers many times forget they have a coupon and forget to apply the coupon, or fail to return completed certificates to the manufacturer or coupon sponsor to receive the rebate or discount. Thus many customers may purchase an item because of a particular coupon or rebate, yet fail to receive the benefit of the coupon or rebate because they fail to complete the necessary process.

Furthermore, a consumer may generally only have access to limited resources for coupons, discounts, rebates, etc. With the advances of e-commerce via the Internet, there are several Web sites that specialize in gathering coupons rebates, etc. Organizers have also made organizing and applying coupons to a particular store more convenient. However, none of these address the underlying problems of optimizing, using, and applying these coupons towards multiple products with multiple merchants. Furthermore, none of these provides a platform to allow the users to maximize the use of these coupons via social networking environment.

Social networking and e-commerce have become two important but, heretofore, distinct applications of the internet. Social networking is a combination of relatively new technologies, and social practices, that allow for individuals to expand their sphere of personal and professional connections through online interactions. Social networking encompasses certain online services that provide a group of individuals with the ability to collaborate with each other over the internet. For example, an individual may register with one or more social networking sites to establish groups of friends or others with common interests to facilitate social interaction. In some cases, such social networking sites are used to expand an individual's base of business contacts that may advance that individual's career. In any event, such social networking sites have been viewed as a tool to advance social interaction between individuals or groups of individuals, whatever their particular goals might be.

The social networks represent both a collection of ties between people and the strength of those ties. Such networks are often used as a measure of social “connectedness”. In addition, social network assist individuals in determining how information moves throughout groups, and how trust may be established and fostered.

In recent years, social network systems have gained immense popularity and attracted millions of individual users. As such, a need exists to integrate and tap into the immense social networking data available with e-commerce or more specifically with the sale and purchase of products or services. The members of social networking sites have a tendency to share personal information and interests. They can be encouraged to share tangible data (such as coupons and gift cards, as well as intangible data, such as preference for particular brand).

Past behaviors, search inquiries, and personal data available on worldwide web created a profile for all users which marketer uses to “recommend” to the users. On the other hand, noise in data causes annoyance with wrong recommendation and advertisements for the users and wasted marketing dollars. So data needs to be qualified with up-to-date user data in a “pull” model instead of the ubiquitous “push” model. The market has mistakenly focused on aggregating and optimizing information on what the consumer may want instead of aggregating VE that can close the deal the users about to buy in the shopping cart.

Existing systems that provide users with account management solutions focus on user name and password management, e.g., keepass, roboform pro, etc. Currently, there is no system that provides the user with a global view of his/her online information and that leverages user input to do corrections such as addition, update, or deletion of this information. Accordingly, it will be desirable to have an identity and profile management solution that allows the user to view his online information, to update and/or delete his information, and to manage this information from a central management system.

In fact, different shopping comparison web sites help user find the best deal for a single item that the user wants to purchase, e.g., Google product search, Bing shopping, Nextag, etc. Currently, there is no system that would allow the user to find the best deals considering the collective set of the products the user intends to purchase and to apply all the VEs the user is entitled to, Accordingly, it will be desirable to have a system that can search and locate the best deals for the user considering all the products the user wishes to purchase and can apply all available VEs automatically as to optimize the deal as well as the purchasing process.

### OBJECTIVE OF THE INVENTION

Accordingly, it is an object of the invention to be a pull model, where the actual or consumed demand drives production.

It is also an object of the invention to provide a downloadable, extension for user to install in a standard browser such as Mozilla Firefox, Apple Safari, Internet Explorer, and Google Chrome.

It is also an object of the invention module to function as a portal for the user to access the exchange platform and the back-end module.

It is also an object of the invention to provide a system which enables a sophisticated optimization algorithm to sift through a myriad of promotions, points, credits and rewards aggregation, multi-item discounts, as well as promotions available from the user's trusted social network.

It is also an object of the invention to provide the user with an email account that the system will propagate and substitute for all other emails in user online accounts, wherein the emails in the account are organized, processed, and presented to the user to provide a quick summary of the coupons, offers, and recent purchase receipts.

It is also an object of the invention to keep track of all purchased items and savings achieved, and facilitate “price adjustment” (in cooperation with merchants) within a pre-determined time period if item prices are dropped by the selling merchant within the specified time window.

It is also an object of the invention to provide the user the option to store sensitive information such as credit cards or login information to accelerate the transactions in multiple points of purchase with multiple merchants.

It is also an object of the invention to calculate tax and shipping cost to provide the user beforehand with the real total out the door purchase price that appears at the end of the transaction.

It is also an object of the invention to populate “a new login information” to all the user's accounts when she decides to change it in all the shopping accounts that she has had with the system disclosed herein.

It is also an object of the invention to identify sources of data leak of user information such as user credit card and personal information.

It's also an object an invention to provide user tangible benefits of keeping the user's online shopping profile secured.

It is also an object of the invention to determine the extent of the “trustworthiness” of various sites, assigning them with a score of trustworthiness.

It is also an object of the invention to provide an exchange platform via a trusted social network where members of a group can deposit, share, and/or trade their value elements (coupons, gift cards, loyalty points, and other promotional items), create merchant-agnostic gift registries and enjoy shop-together tools.

It is also an object of the invention to provide an automated process to optimize a shopping trip, wherein public and personal coupons along with those in the user's trusted social networks are also considered.

It is also an object of the invention to provide users with virtual money that the users may use in transactions relating to exchange of VEs within their trusted social network among other uses.

It is also an object of the invention to provide a system wherein the users can perform certain transactions, trades, and exchanges of VEs through the use of virtual money.

It is also an object of the invention to provide users with an optimization portal that comprises a universal shopping cart component and a wish list component.

It is also an object of the invention to provide users with a universal shopping cart that is available through the extension module of web browser and mobile application.

It is also an object of the invention to provide users with a wish list that is available through the extension module as well as the website.

It is also an object of the invention to provide users with an optimization portal having optimization capabilities.

It is also an object of the invention to provide users with an optimization portal, which finds, saves and shows public and personalized and social VE.

It is also an object of the invention to provide a user the ability to shop with her friends in different geographical locations by enabling her to share her structured optimization portal with others.

It is also an object of the invention to provide a powerful paradigm that allows the user to perform value comparison among items that the user has determined equivalent in her mind, although the items may bear no resemblance to each other, and therefore no heuristic algorithm currently can establish equivalency.

It is also an object of the invention to provide data intelligence for the merchant in order to expedite decision making regarding stock level, supply chain, sales and pricing strategies and other product marketing decisions.

It is also an object of the invention to collect user interaction in database module, which can be analyzed and provided to merchants in an unobtrusive way that doesn't compromise individuals' privacy.

It is also an object of the invention to monitor for any misuse of a user's private data, wherein the system distributes, tracks, and identifies the source of data leak; therefore, the system can help determine the reliability and trustworthiness of a retailer.

It is also an object of the invention to allow a user to copy and paste and/or move one or more items from her general VAULT by dragging the icons of the items to the items list of one or more of her custom VAULT.

It is also an object of the invention to provide the current system on a mobile platform, available as an application on Apple's iPhone as well as Android-based smart phones.

It is also an object of the invention to allow the mobile application to provide the capacity for the user to scan the coupon into a database for use later by the user.

It is also an object of the invention to provide the users with to ability to select, via the mobile App, the groups of friends with whom she wants to share her coupons.

It is also an object of the invention to provide the user with the option of allowing the mobile application, through location detection on her mobile device, to identify which retailers are close to the consumer and subsequently display all the available corresponding coupons to the user, wherein the bar code for that coupon is displayed as to allow the in-store cashier to scan the code and provide the user with the discount.

It is also an object of the invention to provide the user with the ability to scan the tags of supported items in an offline, or brick and mortar, store via the mobile application, and all the coupons that could apply to the item is applied and the results shown on the mobile device.

It is also an object of the invention to provide the user with the ability to add more items or proceed to purchase online via the mobile application the items scanned at a physical store.

It is also an object of the invention to provide the user with access to an inventory of items the user has purchased.

It is also an object of the invention to provide the user with a platform to mix and match items previously purchased with those the user is contemplating whether to purchase, in order to allow the user to determine which items complements her existing wardrobe better.

### SUMMARY OF THE INVENTION

The present invention recognizes that social networking and e-commerce (Social Commerce), previously distinct if not conflicting applications, can be combined to provide great advantages to businesses and their customers. In this regard, the inventors have recognized that conventional e-commerce models do not address certain needs of consumers, merchants, and other interested parties.

More specifically, the present invention allows for consumer to manage online purchases and account information. The system allows the consumer to discover, collect, aggregate, collect, optimize, and automatically apply all kinds of coupons, rewards, gift cards, loyalty programs, etc. (VEs) in real time at the point of purchase. Via these VEs, the present invention brings substantial efficiencies to the online retail business by increasing value for the consumer while simultaneously reducing the cost of goods sold as well as the accounting liabilities for the merchants, (for outstanding VEs) and increasing their promotion redemption rate and sales volume, resulting in higher profits. Furthermore, the present invention also increases the social shopping experience by allowing multiple, geographically separated parties to shop together online.

The present invention comprises an extension module, a universal shopping cart module and a dashboard module that have been designed based on an unobtrusive, user-centric, merchant independent, PULL model (versus the current less effective PUSH model deployed by most companies), providing a day-to-day utility to the users. Furthermore, as a byproduct of its operational model, the present invention will reduce the amount of junk emails its users receive, as well as reduce the unauthorized proliferation of personal information.

The present invention achieves this by providing a non-obtrusive mechanism to the users to automatically take advantage of the VE which include the users' own and the user's trusted social network's VEs, as well as publicly available VEs potentially available from merchants. Users' personal VEs are given to the present system by (a) user forwarding emails to present system for the system to collect coupons emailed, (b) user giving credentials to the present system for the system to scan user's email and process the relevant ones, (c) by scanning promotions via the mobile application of present system; d) User signs up for an email account with this system, and gives permission to the system to replace user email accounts at merchants with this email, so from that point on, all promotional emails from such merchants will be sent to the system and credited to user's account, instead of going to user's previous email account.

Through its downloadable browser extension, the present invention introduces an optimization portal that produces an optimal shopping plan, clearly demonstrating the merchants and the discounts achieved, taking advantage of the VEs mentioned above. The user is at liberty to manually modify the final optimized plan (by selecting and de-selecting items within the optimization portal, and by manually adding additional VEs, and or removing existing VEs and then allowing the present invention to re-optimize the purchase plan. Furthermore, through a facility for trading VEs within the users' trusted social network, the present invention supports and automates a service often done inefficiently and manually today, thereby bringing the powerful “social commerce” element into its business strategy.

Additionally, a user can share her optimization portal with other users who are geographically separated, allowing other users to optionally add to, delete from, or comment on the contents of the universal shopping cart, thereby providing the “shop with pal” shopping experience that presently can only be achieved when such pals are in geographic proximity, or inefficiently via real-time communications going back and forth. Today, unstructured and free form data can be shared via social sites such as Facebook and Google+, however there is no mechanism to share structured and well defined data such as a consumer's shopping cart with a pal. Portal with establishing graphs between products and other users who purchased the same item can show whether an intended to buy items has already been purchased by other members of the users' social network. In one embodiment, the user can't see the identity of those user until the user sends them a message and the other users can decide to reveal their identity or not or add or not to add their review on that item for the user.

The present invention offers the consumer a very straight-forward, non-obtrusive mechanism for making single- and multi-item online shopping very easy and painless, and the assurance that all promotions the user is entitled to has been taken into consideration automatically. As items are put in the shopping cart of a shopping site, the system's browser extension replicates the item in a universal shopping cart. The system then automatically performs the necessary optimizations: if the items cannot be found at any other merchant, “local” optimization is performed per each merchant (e.g., optimization for all items to be purchased from Macy's, optimization for all items to be purchased from Bloomingdales, etc.). If the item can be purchased from other merchants, optimization on those merchants will also be performed, even though the consumer has not shopped there. The system provides the optimal plan and pricing to the user, including the VEs it has used. The user can then request the system to complete the purchase transaction(s). The present invention preliminarily does not intent to do the actual purchasing or fulfillment, and does not dis-intermediate the merchant-user relationship. If anything this relationship is fostered and enhanced. While the system does not actually do the purchasing on its own, based on user's pre-authorization, and information such as Credit Card numbers and preferences, the system can reduce the amount of data entry into the various merchants' systems, so the consumer achieves the “one-click buy” ease of use.

Accordingly, in one aspect of the invention, a system for management of online purchasing and account information for consumer is disclosed comprising: a user computer hosting a front end module; a central computer hosting a back end module; the front end module is installed onto the user's computer through a plugin process; the front end module integrates with a web browser of the user's computer and operates as an extension module to the web browser; the front end module is comprised of a optimization portal module and a social network platform module; the optimization portal module is comprised of a universal shopping cart module; a wish list module (or referred to as VAULT herein); a product comparison module; a payment module and a coupon application module; the social network platform is comprised of a coupon exchange module and a shop with a friend module; the back end module is comprised of a coupon management module; a privacy patrol module; a profile management module and a dash board module.

In one embodiment, the optimization portal module applies a pre-determined algorithm to determine maximum discounts through the coupon application module. In one embodiment, the coupon application module automatically applies available coupons in the universal shopping cart. In one embodiment, the available coupons are public coupons available in the public domain.

In one embodiment, the available coupons are private coupons available only to the user. In one embodiment, the coupons belong to another user wherein another user permits the use of the coupons. In one embodiment, the coupon application module applies preferred coupons based on the algorithm. In one embodiment, the universal shopping cart module duplicates products placed in shopping cart of the user's web browser. In one embodiment, the coupon management module stores all managed coupons. In one embodiment, the managed coupons are comprised of managed private coupons and managed public coupons.

In another embodiment, the coupon management module is comprised of a public crawler module wherein the public crawler module automatically retrieves all available public coupons and stores the public coupons as managed public coupons. In one embodiment, the coupon management module is comprised of a user specific crawler module wherein the user specific crawler module automatically retrieve all available coupons private to the user and stores the private coupons as managed private coupons. In one embodiment, the specific crawler module retrieves all available coupons private to the user by automatically login to the user's merchant accounts using the user's login information.

In one embodiment, the privacy patrol module is comprised of user data tracking module and a trust score module. In one embodiment, the data tracking module is comprised of an active testing prong module wherein the active prong testing module actively sends data packet to one or more target sites to test the target sites' security.

In one embodiment, the trust score module scores the target sites based on the result of the data tracking module's tracking of the target sites' security. In one embodiment, the profile management module is comprised of a merchant intelligence module and a user profile module. In one embodiment, the user profile module is comprised of a user profile input module for the user to input the user's profile and a universal login module wherein the universal login module synchronize the user's login information with the user's merchant accounts. In one embodiment, the universal login module synchronizes the user's login information with the user's merchant accounts by creating a new email address and replaces the user's login email address registered with the merchant accounts with the new email address.

In another embodiment, the merchant intelligence module analyzes the user's behavior to generate merchant intelligence for merchant. In one embodiment, the dashboard module provides for the user to access the system via the user's web browser without the extension module. In one embodiment, the shop with a friend module allows for another user to place or remove one or more products from the user's universal shopping cart module.

In one embodiment, the shop with a friend module allows for another user to place or remove one or more products from the user's wish list module. In one embodiment, the coupon exchange module provides a platform for the user to exchange coupons with other users. In one embodiment, the coupon exchange module further comprises virtual money currency for the user to use to exchange coupons with other users.

In another aspect of the invention, a system for a platform for exchanging coupon comprising a social networking module and an exchange platform module is disclosed. In one embodiment, the social networking module allows for user to interact with other users. In one embodiment, the exchange platform allows users to share coupon with each other. In one embodiment, the exchange platform allows user to sell coupon to each other. In one embodiment, the system operates as an extension to the user's web browser.

In another aspect of the invention, a system that allow for users to shop online together with each other comprising a social networking platform is disclosed comprising a shop with a friend module wherein the social networking platform provides for users to interact with each other and the shopping with friend module provides for users to view and edit each other's shopping cart and wish list.

In another aspect of the invention, a system for management of coupons for online purchasing for consumer is disclosed comprising: a user computer hosting a front end module; a central computer hosting a back end module; the front end module is installed onto the user's computer through a plugin process; the front end module integrates with a web browser of the user's computer and operates as an extension module to the web browser; the extension module is comprised of a coupon application module; the back end module is comprised of a coupon management module.

In one embodiment, the coupon application module automatically applies available coupons to the user's web browser. In one embodiment, the available coupons are public coupons available in the public domain. In one embodiment, the available coupons are private coupons available only to the user. In one embodiment, the coupons belong to another user permitted for user by the another user. In one embodiment, the coupon management module is comprised of a public crawler module wherein the public crawler module automatically retrieve all available public coupons and stores the public coupons as managed public coupons. In one embodiment, the coupon management module is comprised of user specific crawler module wherein the user specific crawler module automatically retrieve all available coupons private to the user and stores the private coupons as managed private coupons. In one embodiment, the crawler spider module retrieves all available coupons private to the user by automatically login to the user's merchant accounts using the user's login information.

In another aspect of the invention, a system for moving icons in a website browser extension is disclosed comprising providing a plug in for a user to download to the user's computer; the download is installed as an extension to the user's website browser; the extension is comprised of a plurality of icons wherein the user can select one or more of the plurality by highlighting the selected icons; the extension further contains an remove icon wherein if the user clicks on the remove icon, all of the selected icons will be removed; the extension further contains a copy icon wherein if the user clicks on the copy icon all of the selected icons will be copied.

In another aspect of the invention, a system for collecting physical coupon wherein the system is disclosed comprised of a smart phone, an application installed to the smart phone, the application utilizes the smart phone to scan the physical coupon and store the coupon on an online database the application further informs a user of the smart phone as it detects the smart phone's proximity of at least one of the stores wherein the store physical coupon can be redeemed.

In another aspect of the invention, a system for mix and matching icons in a website browser extension comprising provide a plug in for a user to download to the user's computer; the download is installed as an extension to the user's website browser; the extension is comprised of a plurality of icons; the extension is comprised of further an inventory module wherein the inventory module contains the plurality of icons for the user to pick and compare; wherein the user can select one or more of the plurality by highlighting the selected icons; the extension is comprised of further a staging module wherein the user can compare the selected icons with each other from the inventory module.

In another aspect of the invention, a method for management of online purchasing and account information for consumer is disclosed comprising: providing a user computer hosting a front end module; using a central computer hosting a back end module; the front end module is installed onto the user's computer through a plugin process; the front end module integrates with a web browser of the user's computer and operates as an extension module to the web browser; the front end module is comprised of a optimization portal module and a social network platform module; the optimization portal module is comprised of a universal shopping cart module; a wish list module; a product comparison module; a payment module and a coupon application module; the social network platform is comprised of a coupon exchange module and a shop with a friend module; the back end module is comprised of a coupon management module; a privacy patrol module; a profile management module and a dash board module.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is a screenshot of an embodiment of an extension in action in a standard browser while shopping at a retailer's online Web site.

FIG. 2 is a screenshot an embodiment of a universal shopping cart in action in response to an item being added by the user to the retailer's shopping cart.

FIG. 3 is a screenshot of an embodiment of a universal shopping cart showing an optimized shopping summary for one particular item.

FIG. 4 is a screenshot of an embodiment of a universal shopping cart showing the available coupons that may be applied to this particular item purchased from this particular retailer.

FIG. 5 is a screenshot of an embodiment of a universal shopping cart showing all the items in the shopping cart of one retailer.

FIG. 6 is a screenshot of an embodiment of a universal shopping cart showing all the shopping carts of the various retailers.

FIG. 7 is a screenshot of an embodiment of a summary of the products selected by the user from the various retailers for potential purchasing.

FIG. 8 is a screenshot of an embodiment of the items selected by the user for purchase along with the result of optimizing and applying the coupons

FIG. 9 is a screenshot of an embodiment of an optimizing function suggesting potential savings and alternative purchasing plans to the user.

FIG. 10 is a screenshot of an embodiment of the user's new shopping plan according to the system's suggestion regarding the use of additional coupons upon satisfaction of the its conditions.

FIG. 11 is a screenshot of an embodiment of a summary of the system's comparison shopping function which enables the user to comparison shop across multiple merchants involving multiple products.

FIG. 12 is a screenshot of an embodiment of a summary of system's comparison shopping function showing the price and the saving of a particular product across various retailers.

FIG. 13 is a schematic diagram illustrating the overview of the system in relation with the user, the retailer, and with social networking.

FIG. 14 is a schematic flowchart illustrating the browsing, optimization, and purchasing process with retailers through the system's extension.

FIG. 15 is a schematic flowchart illustrating the data management process of the user's financial information, available coupons, and social networking information.

FIG. 16 is a schematic flowchart illustrating the system email registration, management, and optimization process.

FIG. 17 is a schematic flowchart illustrating the social networking component of the system in relation to retailer e-commerce component.

FIG. 18 is a schematic flowchart illustrating the shop with friends component of the social networking e-commerce component.

FIG. 19 is a schematic diagram illustrating and providing an overview of the online purchasing and account management system.

FIG. 20 is a screenshot of an embodiment of the user's available options in her custom VAULT.

FIG. 21 is a screenshot of an embodiment of the user copying or moving selected items to her custom VAULT list.

FIG. 22 is a schematic representation of a user scanning and storing a coupon via a mobile App into an online database.

FIG. 23 is a schematic representation of a user scanning the barcode and adding the corresponding item into her universal cart online.

FIG. 24 is a schematic representation of the mobile App providing the user with a list of available coupons for nearby stores.

FIG. 25 is a screenshot of an embodiment of the user's shopping history of the items the user has purchased from the various retailers.

FIG. 26 is a screenshot of an embodiment of the user's inventory drawer where the user can use as a mix and match workstation.

FIG. 27 is a screenshot of an embodiment of the user selecting items from her inventory of already purchased items to be mixed and match with items the user is contemplating purchasing.

FIG. 28 is a screenshot of an embodiment of the user using the mix and match workstation involving already-purchased items and potentially to-be-purchase items.

### DETAILED DESCRIPTION OF THE INVENTION

The present invention aggregates information about online consumer accounts by scanning and processing consumer emails and loyalty accounts or through direct consumer or her trusted network input. Then the system requests for consumer authorization to access the discovered online accounts. The system clusters and organizes the information found in the online account profiles and presents this information back to the consumer through a dashboard. The consumer can correct/delete any erroneous data and add any missing information and the system subsequently updates the consumer's affected online accounts. The system allows the consumer to organize and categorize her online accounts to her satisfaction, as well as changing account profiles at merchants through the system.

Simultaneously, through the present invention's novel techniques, a direct communication channel will be established between the individual consumer and the merchants, providing a channel for real time flash sales, issuing promotions in-season right before the transaction based on consumer's life time value for the merchant that assures real time redemption. This invention not only provides better service level and customer experience for the consumer, it also results in increased sales for all merchants.

In fact, a potential for this invention is the creation of “private in-season sale” for designer goods. Currently luxury goods merchants are prevented by the designers/manufacturers from discounting the products (from fear of brand dilution and channel conflict). By giving the current system exclusive and private discounts to be applied to their consumers, such high-end merchants are able to effectively lower the price of the goods without diluting the brands and violating their contractual obligations to the designers/manufacturers. This has the potential of removing several current barriers that are controlling the hyper growth of online shopping, and increasing the growth rate of online shopping well beyond the current 19% per year. Growth of online shopping results in a reduction of cost of goods sold, higher efficiency, and increased profits on the part of the merchants.

More specifically, through its optimization portal, the present invention provides an unprecedented shopping experience for online shoppers, bringing simplicity, substantial timesaving, and optimal value to single- and multi-item online shopping. While initially this will be applied to the retail industry, the concept is expandable to multiple industries such as travel, home improvement, hospitality and services, etc. Through its sophisticated optimization algorithm that sifts through a myriad of promotions, points and rewards aggregation, multi-item discounts, as well as promotions available to the user's trusted social network (collectively referred to as “Value Elements” or “VEs”), the present invention comes up with an optimal shopping strategy across multiple merchants, in order to provide the consumer with better value while also saving time. In the process, and with the cooperation of the consumer, the present invention produces a much more current and refined profile of the user for micro-casting and data mining purposes (a huge industry problem), as well as earning the consumer's trust by identifying sources of leaks of consumer's sensitive information and taking corrective action. Furthermore, the present invention achieves this through a Pull Model, as opposed to the current less effective Push Model deployed by the industry, which inundates the email boxes and regular mailboxes of potential consumers with unwanted or unmanageable promotional emails and regular mails. Best of all, the entire process will happen seamlessly and transparently for the users, via an extension to their favorite browser.

The system also assembles any promotions available from merchants, either through direct connection with the merchants (through agreements) or via affiliate marketing programs (e.g., Ad Network). In addition, any credits and gift cards given to the user by a merchant, will be entered into the system, either by the user (through having her emails forwarded to the Company for processing her email, or allowing the system to extract it from the merchant's site by using her credentials at the merchant, or entering into the system manually) or delivered by the merchant directly to the system to be allocated to her account. Ideally, over time merchants will upload directly into the system all promotions related to the users of the system, as opposed to inundating the user's mailbox as well as e-mailbox with promotions, resulting in substantial improvements in the marketing campaigns of the merchants.

In one embodiment, the present invention contains a universal login module which has the capability to change user login information and passwords at all user registered accounts with the system. In this way, the system can strengthen the consumer's privacy and protection by automatically propagating such information to merchant sites on behalf of the consumer.

In another embodiment, the present system or the universal login module will also provide the consumer with an email account that the system will propagate and substitute for all other emails in user online accounts (e.g., if the consumer has registered with a merchant with email Jane.Taylor@gmail.com, the system will create a new email, such as Jane.Taylor@retail.the-present-invention.com and will automatically update the merchant's site, having received the user's permission to do so). This allows all future emails containing promotions, etc, from the retailer's website to be sent this new email. Emails in this account are organized, processed, and presented to the user in a “dash board” fashion that helps the user obtain a quick summary of his coupons, offers and recent purchase receipts (Current email solutions are focused on personal communication). In addition, the promotions are also allocated to the user's account, to be used for future purchases.

In another aspect, the system maintains a universal shopping cart module. The shopping cart provides the system with a global view of user needs and allows the system's value optimizer to create an optimized purchase plan for the user (given all potential Value Elements at single or multiple merchants). For example, the value optimizer may bundle items together to be purchased from a particular retailer so that the items exceed a certain dollar amount threshold and therefore qualify for additional discount or free shipping to the user, among other benefits. The value optimizer also takes into account personalized user value elements as they are retrieved from the users' online accounts, emails, and other electronic medium the users use or entered by the users or shared by her trusted network for future use.

The system may also act as a recommendation engine for items that have been placed in optimization portal for future purchase or in a queue for further consideration. The system uses two criteria to recommend items first in the queue and then in the optimization portal: First, addition of the item(s) will bring the total to a price threshold that will qualify for additional discounts. Second, inclusion of such items will bring the total to the level the user is psychologically prepared to pay for. For example, if a user has chosen an item that, prior to discounts, costs $2000, and subsequent to the application of VE's it will cost $1600, the system will include other items (from the user's VAULT) that would bring the total close to $2000, which is the psychological mark for the user. Of course, the user is at liberty to reject the additional items.

The system also maintains the optimization portal for accomplishing complex optimizations and real equivalency. The optimization portal is a powerful paradigm that allows the user to perform value comparison among items that the user has determined equivalent in her mind, however the items bear no resemblance to each other, and therefore no heuristic algorithm currently can establish equivalency. The following example elucidates this concept: User A wants to go to a wedding. She likes a long black gown at Neiman Marcus, a short white baggy dress at Macy's, and tight medium height dress at Bloomingdale's. She would be happy with any of them, but she does not desire to purchase all three. No current “recommendation engine” can establish the equivalency of these dissimilar outfits.

The advanced capabilities of the shopping cart within the optimization portal solves the issue in the following way. The shopping cart is divided into two types of sets: (1) Set “type one”—the shopping cart will consider only one item within this set during each optimization pass. If there are 3 items in this set, the shopping cart will perform 3 optimization passes, and in every pass it will select one of the items from this set; and (2) Set “type all”—the optimization portal will consider all the items from this set.

Therefore, during the optimization process, the optimization portal will iterate over each item of the type one sets, plus all the items in the type all sets. In the particular example above, assuming there is only one set of type one, and one set of type all in User A's shopping cart. Assuming User A has selected all three gowns and arranged them in the type one set in her shopping cart, and the rest of the items she has shopped for are arranged in the set type all.

The optimization portal will then give her the desired result, which is an optimization based on each gown plus the rest of her wish list, so she is presented with three (3) different plans and she can choose the one in which she is interested. User A has full control over the shopping cart, and can select and de-select items in the shopping cart at will, or move them from one set to another (of the same or different type). The user can allocate multiple sets of either type in her optimization portal, and the optimization algorithm will iterate accordingly. However, for most cases, one set of each type is sufficient. This automation of identifying the “best value” plan is very powerful for complex comparison shopping (and in which all potential Value Elements are considered, and does not exist anywhere at this time to the best of our knowledge).

Specifically, below is an example of how the optimization algorithm operates: merchants like Macy's, Bloomingdale's etc distribute several coupons that offer various kinds of discounts to the customers. Some of these are publicly available on their web sites or on other websites that can be found through search engines. Coupons are also distributed to customers through email or regular mail. A customer shopping online on these websites faces the challenge of finding out the best possible way of breaking down the purchase into multiple transactions where a different coupon code can be used with each transaction to get the best deal. Some coupons give a discount if the total amount crosses a threshold, whereas some others give certain percent off on selected items in the store. Finding the optimal way of utilizing the coupons you have can be a very tedious task especially when someone is shopping in bulk.

Suppose User A visits Macy's website to shop for the upcoming wedding of her friend. The user decides to buy a pair of shoes—$100, a dress—$250 and a necklace $80 for the wedding. The user has 3 coupons that can be applied towards purchase at macys.com. Specifically, the coupons are:

Merchant Coupon

Coupon Code VE1 - Enjoy $10 off your purchase of $300
Coupon Code VE2 - Enjoy 20$ off women's shoes
Coupon Code VE3- Enjoy 10% off a wide variety of items except jewelry

Accordingly, the available scenarios to use the 3 coupons are:

| Option | Saving |
|---|---|
| Choice 1 | If user A purchase all 3 items using VE1, user A spends |
| | 100 on Shoes |
| | 250 on dress |
| | 80 on necklace |
| | Total $430 − $10 (VE1) = $420 |
| | User A saves $10. |
| Choice 2 | If user A purchase all 3 using VE2, user A spends |
| | $100 on shoes (VE2 applies) |
| | 250 on dress |
| | 80 on necklace |
| | Total $ $430 − $20 (VE2 gives 20% on shoes) = 410 |
| | User A saves $20 |
| Choice 3 | If user A purchase all 3 using VE3, user A spends |
| | $100 on shoes (VE3 applies) |
| | $250 on Dress (VE3 applies) |
| | $80 on necklace |
| | Total $ 430 − $10 (VE3 gives 10% off on shoes) − |
| | $25 (VE3 gives 10°% off on dress) = 395 |
| | User A saves $35. |
| Choice 4 | If user breaks down the purchase as follows |
| | Transaction 1 - Purchases dress using VE3 |
| | Dress - $250 − $25 (VE3 gives 10% off), |
| | user A saves $25 |
| | Transaction 2 - Purchase shoes using VE2, |
| | Shoes $100 − $20 (VE2 gives 20% off), |
| | user A saves $20 |
| | Transaction 3 - Purchase Necklace using VE1 but the |
| | necklace is $80 and VE1 cannot be used for it |
| | because its only applicable if the amount is more |
| | than $300. |
| | Necklace $80. User save $0 |
| | User A saves $45. |

While user A believes choice 4 maybe the way to go but without applying these products and coupons to the merchant's website, the user is not sure if the user would be paying higher in shipping. By now however, user A is too exhausted to run more scenarios in her head. Moreover with tax and shipping considerations, the problem is likely to get even more complicated.

The present optimization portal module with the algorithm aims at solving this problem for shoppers by running through all possible scenarios and finding the best possible way to break down the purchase into multiple transactions to optimize the use of available coupons. For example, the portal module finds the perfect cart combination to optimize the purchase in three phases:

Phase 1—For each product and each possible product combination find the savings by applying every single coupon available. This is done by creating carts on the merchant's website through APIs and gathering accurate and up-to-date results. This process also ensures that tax and shipping are taken into consideration

### EXAMPLE

Given products P1, P2, P3 and Coupons VE1, VE2, VE3 gather the following facts

Product P1 alone bought using coupon VE1 gives savings S1-1

Product P2 alone bough using coupon VE2 gives savings S1-2

Products P1 and P2 bought using coupon VE3 gives savings S3-12

Continuing along this path we gather the following facts by creating shopping carts at merchant's website and getting updated results:

| Product(s) | VE | Savings |
|---|---|---|
| P1 | VE1 | S1-1 |
| P2 | VE1 | S1-2 |
| P3 | VE1 | S1-3 |
| P1P2P3 | VE1 | S1-123 |
| P1P2 | VE1 | S1-12 |
| P1P3 | VE1 | S1-13 |
| P2P3 | VE1 | S1-23 |
| P1 | VE2 | S2-1 |
| P2 | VE2 | S2-2 |
| P3 | VE2 | S2-3 |
| P1P2P3 | VE2 | S2-123 |
| P1P2 | VE2 | S2-12 |
| P1P3 | VE2 | S2-13 |
| P2P3 | VE2 | S2-23 |
| P1 | VE3 | S3-1 |
| P2 | VE3 | S3-2 |
| P3 | VE3 | S3-3 |
| P1P2P3 | VE3 | S3-123 |
| P1P2 | VE3 | S3-21 |
| P1P3 | VE3 | S3-22 |
| P2P3 | VE3 | S3-23 |

Phase 2—Arrange facts into cart combinations by adhering to the following rules:

1. A combination contains one cart per coupon. 3 coupons result in 3 carts.

2. Facts gathered for a coupon are added to the cart created for that coupon.

3. Facts are paired with all other facts as long as it results in a valid cart combination.

Validity of the cart combination is verified using the following rules:

1. Every combination contains all products (P1, P2, P3)

2. No products are repeated in a cart combination.

Following these rules we get the following possible cart combinations:

Cart Combinations

| VE1 | VE2 | VE3 | Savings |
|---|---|---|---|
| P1 | P2 | P3 | S1-1 + S2-2 + S3-3 |
| P1 | P3 | P2 | S1-1 + S2-3 + S3-2 |
| P1 | P2P3 | | S1-1 + S2-23 |
| P1 | | P2P3 | S1-1 + S3-23 |
| P2 | P1 | P3 | S1-2 + S2-1 + S3-3 |
| P2 | P3 | P1 | S1-2 + S2-3 + S3-1 |
| P2 | P1P3 | | S1-2 + S2-13 |
| P2 | | P1P3 | S1-2 + S3-13 |
| P3 | P1 | P2 | S1-3 + S2-1 + S3-2 |
| P3 | P2 | P1 | S1-3 + S2-2 + S-1 |
| P3 | P1P2 | | S1-3 + S2-12 |
| P3 | | P1P2 | S1-3 + S3-12 |
| P1P2P3 | | | S1-123 |
| P1P2 | P3 | | S1-12 + S2-3 |
| P1P2 | | P3 | S1-12 + S3-3 |
| P1P3 | P2 | | S1-13 + S2-2 |
| P1P3 | | P2 | S1-13 + S3-2 |
| P2P3 | P1 | | S1-23 + S2-1 |
| P2P3 | | P1 | S1-23 + S3-1 |
| | P1 | P2P3 | S2-1 + S3-23 |
| | P2 | P1P3 | S2-2 + S3-13 |
| | P3 | P1P2 | S2-3 + S3-12 |
| | P1P2P3 | | S2-123 |
| | P1P2 | P3 | S2-12 + S3-3 |
| | P1P3 | P2 | S2-13 + S3-2 |
| | P2P3 | P1 | S2-23 + S3-1 |
| | | P1P2P3 | S3-123 |

Once the facts are arranged into combinations like shown above, the savings for each combination are computed by adding the savings for all the facts in that combination. The best combination is picked out simply by finding the combination that gives the most savings. This is suggested to the shopper as the most optimal way of breaking down the purchase into multiple transactions.

Phase 3—If products P1, P2, P3 are available from multiple merchants (say merchants A and B), then the optimization will iterate the algorithm over merchants A, then B, then C. For example, the algorithm will consider P1, P2, and P3 from Merchant A first. Next, it will try P1, and P2 from A, and P3 from B. Next it will try P1 from A, and P2 and P3 from B. Next it will try P1, P2, P3 from B (and nothing from A). Obviously if a product is available from only one merchant, certain iterations (for that product at other merchants) will be avoided.

In addition, the system has an optimization portal component with a wish list. The system will allow a user to share her wish list, either in view-only mode, or in view-and-edit mode, with one or multiple parties or friends. In view-only mode, friends can see what is in the user's wish list, and can provide commentary on it (such as like/dislike, suggestion for alternatives, etc.). If view-and-edit mode, friends can actually add, delete, share, move to other wish lists, or place items in the user's wish list. This is a very powerful concept, as it allows close friends who are geographically separated to shop online together or for each other (Merchant agnostic gift registry); this social process increases human interaction and provides social bonding. The process also acts as a viral marketing capability for the present invention, which in turn will increase online shopping by bringing more users to the fold. The present invention has the capability to notify the users that the item(s) has been purchased by others belonging to a tagged wish list or independently.

Specifically, the optimization module is comprised of at least two components: an active universal shopping cart module and a wish list module. The optimization module operates a web browser extension which functions with different browsers (Chrome, FireFox, Safari, and Explorer), and captures all the items a user intends to purchase. The user has the option of executing the transaction, compare items, or keeping them in wish list for future optimizations or purchase or other functions such as mix and match with old and new items, priority sorting in a queue. Consumers can remove or add items in the merchant's shopping cart. The active shopping cart provides for “best value” by taking into consideration the time-sensitive current and future promotions, public and personal promotions, as well as loyalty points such as frequent flyer or frequent shoppers points, as well as threshold spending benefits, such as if the consumer spends a certain amount of dollars with a merchant, additional discounts or benefits accrue.

The optimization algorithm used by the wish list is event driven. Several events could invalidate the optimized result: Between the time the optimized results are presented to the consumer and the time the user decides to execute the purchase transaction, it is possible that one of the coupons could be used by another user (e.g., this could be a coupon from the user's trusted social network). The system keeps track of the dependency between the results of the optimization and the coupons used by it. When a coupon is withdrawn from the system, results are invalidated and a new optimization is triggered. The consumer is notified of this event via messages (real-time on the screen and/or text messages, or other means). VEs could be withdrawn due to expiration, use by another user, or other events. Likewise, new VEs may be introduced into the system that will affect the optimized results. The same way, the system invalidates the results and re-executes the optimization algorithm. At the time the consumer proceeds to purchase, the system will acquire a lock on all dependent coupons and completes the transaction by directing the user to one or more filled merchants' shopping carts. At other times the “shared” coupons remain unlocked and can be used by another consumer.

In another aspect of the invention, the universal shopping cart allows user to shop from multiple sites simultaneously in that user may place items from merchant A and items from merchant B simultaneously in the universal shopping cart. Specifically, this allows user to mix and match and compare. Specifically, presently one of the biggest short coming of the shopping experience features from online is the fact the users can't match intended to buy products with the user's current properties until the user buys them and put them together in the privacy of her closet. For example, the present invention allows the user to put all the products from different merchants in the universal shopping cart and compare with all the items already purchased in the shopping history and even what she has in her closet.

In another aspect of the invention, user can see an overview and detailed view of her total overall saving (daily, monthly and annually . . . ) as well as merchant by merchant to determine how much she saves and with whom, as this is the best way to turn the customer into a loyal customer.

In another aspect, the system has a social network marketplace component. More specifically, the present invention involves the creation of a marketplace where members of a trusted social network can deposit their VEs, share or/and trade such VEs. The owners can either share or assign value to each of their VEs. At the time that a consumer asks the present invention to optimize a shopping trip, in addition to the public and personal VEs, the VEs in the user's trusted social networks are also considered. The free ones are obviously used in the optimization calculations. The ones with price tags are used if the optimization engine determines an economic benefit to the consumer, i.e., the price differential between the face value of the coupons and what the owner demands can result in a discount for the user who is doing the shopping. In another embodiment, the optimization engine assigns a value to each VE in the trusted network based on simultaneous demand, and will allow the owner to override.

Specifically, the system of discounts, gift cards, rewards, and coupons (VEs), includes all that is available to the consumer as well as within the consumer's social network. Within this network, the system creates a market place where each coupon can be shared freely or is assigned a value for trading purposes within the trusted network. This credit applies to providing consumer's account in the system when her coupon is used by another consumer. The VEs could be of three varieties: (a) one time use, or (b) multiple use by a single user, e.g., a 20% discount coupon all day for a single day chosen by the user within a specific period, or (c) multi-use (can be used by multiple users). The value of a VE can be set either by the owner, or by the system in the absence of owner's input.

In another aspect, the system will be designed as an extensible system where the system and/or third party develops can add capability, e.g., seeing both public and pals' online reviews in one place, set preferences for a specific brand, store, material, etc., virtual fitting rooms, closet organizers and workstation for mix & matching.

In one embodiment, the system keeps track of all purchased items and savings achieved, and in cooperation with the offering merchant, facilitates “automatic price adjustment” within a pre-determined time period if item prices are dropped by the selling merchant within the specified time window. The system does not need to provide any sensitive information such as credit card or login information to the merchant, unless users wants to accelerate the transaction, allowing the system to use the stored credit card information and login information. The system extension can also calculate tax and shipping which can be detrimental in the users' shopping experience, as almost half of the 71% of users who abandoned their shopping cart complain about the shock of the real total at the end of the transaction according Forester research.

As described earlier, the present invention can populate “A new Login Information” to all the user's accounts when she decides to change it in all the shopping accounts that she has had with the system at a glance. This functionality allows the system to enhance user's privacy. Identification of user's data leak by third party sites—the system is capable of identifying sources of leakage of user information such as user credit card and personal information. It is well known that a number of sites sell part or all of any information collected from their users in order to generate additional income. The present invention's algorithms for detecting, as well as remedying, the situation may help the industry to engage in self-regulation, and therefore avoid new statutes that may have restrictive effects on the online shopping industry. For example, by using the system generated email, such as Jane.Taylor@retail.the-present-invention.com, the system can detect what unsolicited emails are coming to the user's email. The system will track down those unsolicited emails by generating additional ‘token’ emails and registering at suspicious sites until the sources of leaks are determined.

In another embodiment, the system also provides users with advanced privacy patrol and privacy control. With access to user's online accounts, the system can monitor for any misuse of her private data via an algorithm. The basic idea of the algorithm is that the system can act as a data distributor which provides retailers with data obtained from the customers. If some of the data are leaked and found in an unauthorized place (e.g., on the web or someone's laptop), the system can assess the likelihood that the leaked data came from one or more retailers, as opposed to having been independently gathered by other means. The present invention uses data allocation strategies (across the retailers) that improve the probability of identifying leakages. These methods do not rely on alterations of the released data (e.g., watermarks). In some cases, the system can also inject “realistic but fake” data records to further improve the chances of detecting leakage and identifying the retailer that is responsible for compromising the data.

In one other embodiment, the present invention also has a component for scoring a Web site's “trustworthiness”, such as trust score module. The system, in the process of leakage detection, can determine the extent of the “trustworthiness” of various sites, and assign a score to each site. The present invention's technology can be used by these sites to certify their trustworthiness (similarly to how FICO scores are used to rank credit worthiness of a borrower).

The present invention also includes a virtual money component to allow for and enhance various e-commerce transactions. Instead of getting involved in a direct sale, the system can facilitate an e-commerce transaction and purchase and sales of coupons via a created virtual money for exchange between the users. When consumer signs up to use the system disclosed herein, the user may be given a certain amount of virtual money, such as Twenty-Five (25) virtual money. This virtual money are used to buy coupons from others. To earn more virtual money, the consumer can invite more people to join or the consumer can buy virtual money with her credit card. For each person that joins from the consumer's invite, she earns more virtual money. The cost of the virtual money is a fraction of what you would pay for regular coupon. The cost of the virtual money should be roughly 25-75 percent of a regular coupon or gift card or store credit, depending on the value in the eye of beholder. At the same time, when a consumer sells VEs, the user will get virtual money credited to her virtual account.

While the user data mining field has improved intelligence on the part of the merchants, its wide availability and adoption by almost all merchants has reduced the competitive advantage for the merchants. In effect, the playing field for the merchants is leveled again, and the focus is shifting back to traditional values. Over time, through executing purchases for consumers, the system collects substantial amount of information about what an individual consumer is buying (individual trends) and what items are more popular and in demand (macro trends). Furthermore, by analyzing the price patterns of items a consumer selects across her multiple shopping carts, the system acts like a personal shopper who has unique and proprietary information about the purchasing power of the consumer, which is missing from brick and mortar and those individual merchants that will allow for more accurate targeting of the consumer by them, e.g., if a user is putting $2000 designer handbags in her cart, then likely she is also receptive to $1000 shoes, whereas if a consumer is selecting $200 handbags, likely she is not interested in $1000 shoes, rather sub $200 shoes.

By having this information, the present invention can be a valuable market intelligence asset to enterprises, and at a much lower cost and higher effectiveness than their current tools and mechanisms. Such accurate and high quality data that is obtained in real time and directly from the users and their lifetime value and needs for the merchant can substantially enhance the merchant's ability to implement optimal pricing, promotion, and inventory management strategies. For example, large high-end enterprises can introduce the concept of “private in-season sale” without breaching any of their contractual obligations with their providers, a concept that heretofore has been very difficult for these merchants to implement.

As such, the present system contains a merchant intelligence module. Because the present invention can see across users' optimization portal, therefore at any time it has complete knowledge of the aggregate demand for a particular item (within its user base). For example, if a particular designer handbag appears in 1 000 shopping carts, the system can check the inventories of the merchants (through agreed upon Application Programming Interfaces—APIs), and notify the users that the aggregate existing inventory is perhaps less than the actual demand, e.g., there are only 200 of that particular designer handbags are left. This may prompt a population of the users to proceed to purchase the handbag, and not wait for additional promotions.

Furthermore, if items are dragged to the VAULT (wish list module) by consumers, but not purchased within a certain period of time, the invention can recognize that there is interest in the item(s) by consumers, but that the price is too high. Therefore, through agreed upon API's, the system can negotiate a better price for the item(s) in the aggregate (presenting aggregate demand) with the merchants resulting in purchase of the items by the interested consumers.

As the effectiveness of the campaign of the present invention on behalf of the consumers becomes more evident to the merchants (via reports on volume of transactions with each merchant, as well as other data) on their marketing efforts, it is anticipated that more marketing budget will be diverted to advertising through the method and system of the present invention via private promotions exclusive to participating clients, and less budget towards the traditional, less effective promotional models. This results in a De Facto Standard for promotions, and has the potential of making the present method and system a central player in online shopping.

In another aspect, the present invention also provides various other advantages over other traditional promotional methods. For example, the present invention allows for in-season private sale, addressing a major issue in high-end retailing. Before the end of the season, often the designers/manufacturers of high-end products prevent retailers from promoting their products before the end of the season for fear of diminishing the brand's power and cache. This restriction limits the retailer's ability to manage inventory and forecasting in an optimal fashion. The present invention provides the retailer the ability to determine optimal pricing via controlled private promotions that rescue their handcuffed money they invested in buying from designers.

Furthermore, the private promotions could be of variable amount. Assume merchant A has put a variable discount of say, up to 20%, at the disposal of the system, but merchant B has not. Further assume both merchants are carrying like items. In a competitive situation where a set of items can be purchased by the consumer from merchant A as well as merchant B, the system can apply the variable private discount of merchant A, sufficiently to make it more price competitive than merchant B for the consumer. For example, if the total price, after the application of all VEs is $1000 for merchant A and $900 for merchant B, then the system can apply 11% (of the variable up to 20% additional discount) to merchant A's cart to bring the price down to below $900, therefore steering the deal towards merchant A.

In yet another aspect of the invention, the user may, after signing in and creating some custom VAULTs, copy and paste and/or move items in the VAULT (wish list module) onto different lists. More specifically, when the user has created some custom VAULTs, these VAULTs will be available to the user upon signing into the user's account. In the user's VAULTs, the user can view various items represented by individual tiles for each item. The user can then select an item by clicking on the tile and releasing the click. The tile is only selected on the release of the click, and any such selection is indicated by a red border. The user can repeat the selection process until up to 5 items (tiles) are selected and highlighted with red boarders. Next, the user can select any one of the highlighted (selected) tiles by holding the mouse clicking, that is, clicking and holding. Furthermore, while continuing to hold on to the click on the tile, the user can drag the selected items away from their starting location. Once the drag operation commences, the system automatically displays two target areas below each of the VAULT icons and names. The two target areas below the VAULT icons and names contain one area labeled “Copy” and one area labeled “Move”. If the user slides the selected items to “Move”, the icon is highlighted to indicate to the user which action will be taken. After the user drags the tiles to the “Move” icon and releases the mouse click, all items are moved to that target VAULT and disappear from the starting location. If the user slides the selected items to “Copy”, the icon is highlighted to indicate to the user which action will be taken. After the user drags the tiles to the “Copy” icon and releases the mouse click, all items are copied to that target VAULT and the original items snap back to their starting location.

In another aspect of the invention, an application on Apple's iPhone as well as Android-based smart phones serves as a mobile platform to provide multiple capabilities for the present system. The front end functions as an application within the smart phone. Specifically, since the standard browsers on mobile platforms prevents the use of plug-ins and extensions, the present invention uses the application to invokes a browser within it, in which the users can shop at the websites of the supported merchants. Since the browser runs within the context of the application, the application has full control over the user's actions, and can implement equivalent functionality to the browser extension available on PCs and Laptops. Additional functionality for the present system are added as the present system integrates the mobility and computability of the smart phone.

First, the application allows the user to scan and input coupons provided by the Merchants. Generally, merchants send various coupons to consumers via regular mail. As an example, Macy's sends a package of coupons (usually four) in one envelope to its frequent shoppers as an encouragement for further shopping. These time limited coupons are either of the form of a percentage discount off the value of shopping, or a fixed dollar amount discount based on a certain minimum dollar level of shopping. Furthermore, the coupons provide a code that can be used when shopping online (for single time usage), and a bar code if shopping offline at a Macy's retail store, at which point the sales person will scan the coupon with the register's special scanner (again, for single time or single day use).

The mobile application provides the capability for the user to scan the coupon into the database of the system disclosed herein. Once scanned, the system's image recognition technology to parse the contents of the coupon, and then displays the contents in structured fashion back to the user so the user can confirm the contents. Then, after the user confirms, the user selects with which groups she wants to share these coupons.

Second, the mobile application provides the user to use her coupons even when shopping in an offline, or brick and mortar, store. The mobile application can identify (if location detection has been enabled by the consumer on her mobile device) which retailer(s) the consumer is in or close to physically, and the mobile application can display all coupons to which she is entitled. Or if the user is in a store from which she has already have products stored in her VAULT(S), mobile application gives a notification where in the store she can find the merchandise to try or if there is any VE applicable to that product at this moment. This will create another opportunity for the merchant to offer VEs to the shoppers to entice them buy at the store. If she picks merchandise with an applicable coupon or other VEs, the bar code for that coupon or gift card is displayed so the in-store cashier can scan the code and the consumer can get the discount.

Finally, the mobile application can also function to add items scanned in a physical store to the universal shopping cart online, thereby integrating the offline and online shopping experience. More specifically, if the user scans the tag of an item in a supported, offline store, that item is added the consumer's universal cart online, and all coupons that could apply to the item are applied and the results are displayed on the mobile device. The user can then choose to proceed to purchase (online via the mobile app), or add additional items the same way and then proceed to purchase. Once the item has been added to the universal cart online, the behavior of the system is as described in this invention disclosed herein.

### DETAIL DESCRIPTION OF THE DRAWINGS

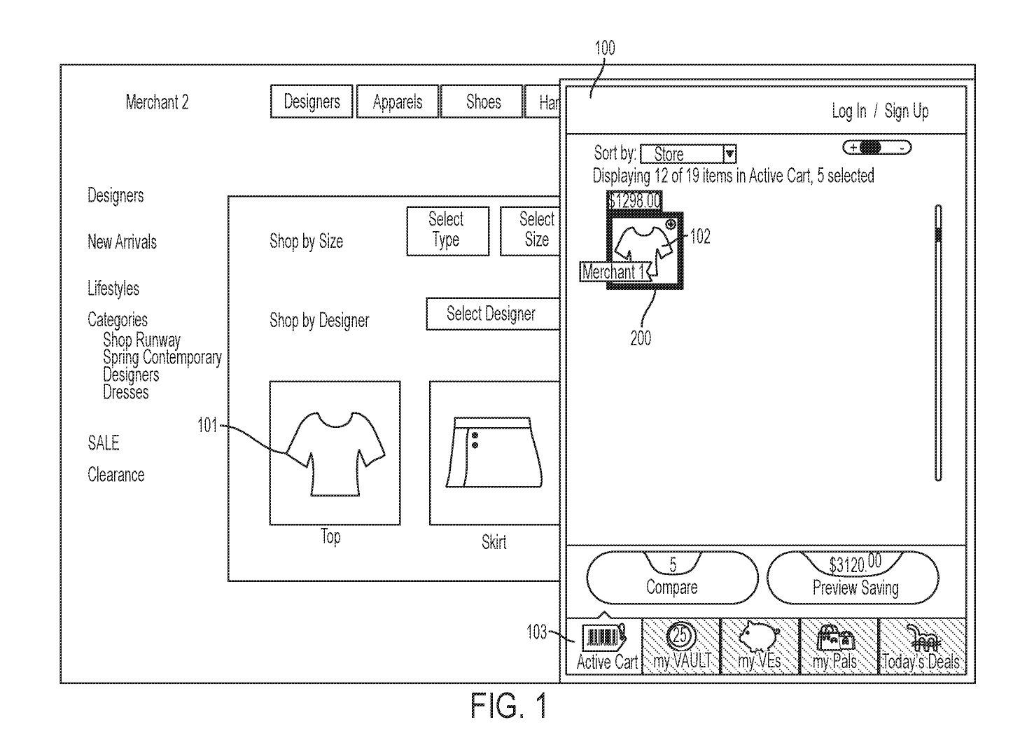

The invention will be described in the context of a preferred embodiment. Referring to FIG. 1, a shopping web site of a retailer is accessed via a standard web browser such as an Internet Explorer, Mozilla Firefox, Apple Safari, or Google Chrome, etc. with a downloadable extension 100 installed as disclosed in the present invention. The user can proceed to browse and shop online with the retailer as usual. Upon the addition of a desired product 101 into the retailer's standard shopping cart, the system via its extension will also place the same item 102 into the system, shopping cart 103, referred to here as Active Cart, in parallel to the retailer's standard shopping cart. This process can be repeated with multiple online retailers to allow the user to comparison shop and find the best deal.

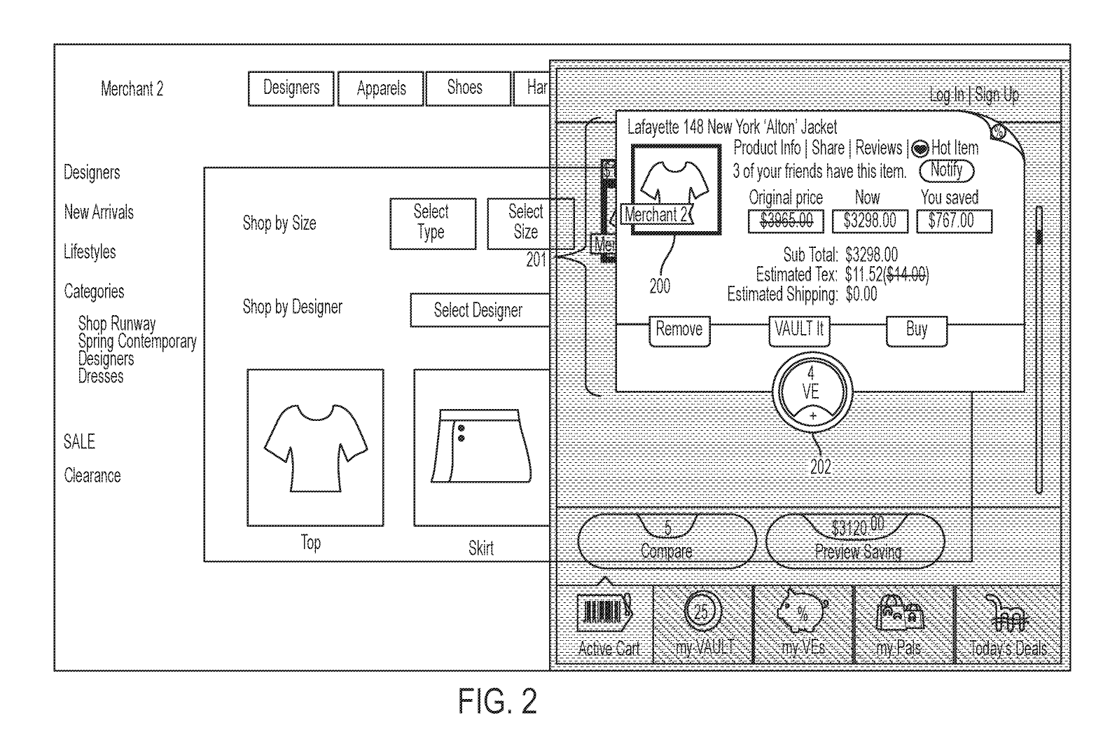

Referring to FIG. 2, upon having the desired item(s) 200 in the system's shopping cart, the system is able to optimize 201 the user's selection of desired products with any available Coupons 202, which could also include gift card, store credits, rebates which herein referred collectively to here as Coupons.

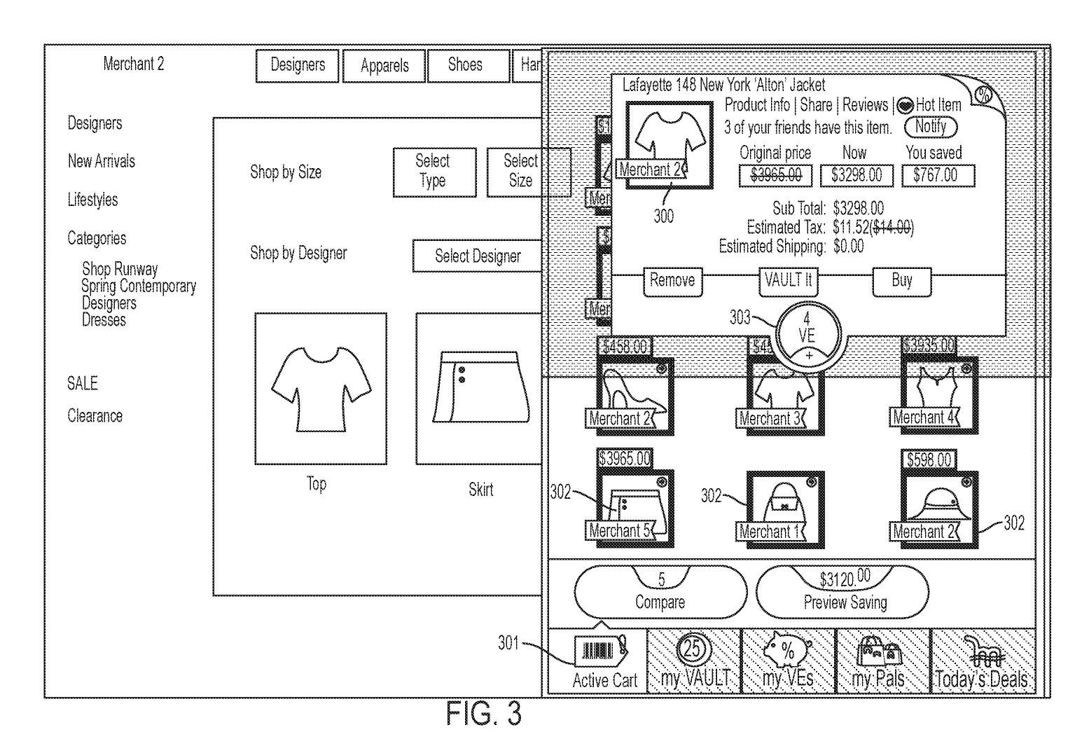

Referring to FIG. 3, upon shopping at various online retailers of the user's choice, a designer shirt was placed into the retailer's shopping cart. In parallel, this same designer shirt 300 is automatically placed into the system's shopping cart 301. The user is also able to see all the other products 302 the user has added into the respective shopping carts of the various online retailers in the system's shopping cart 301. The system is, then, able to apply any available coupons 303 to each of the products with respect to the retailers.

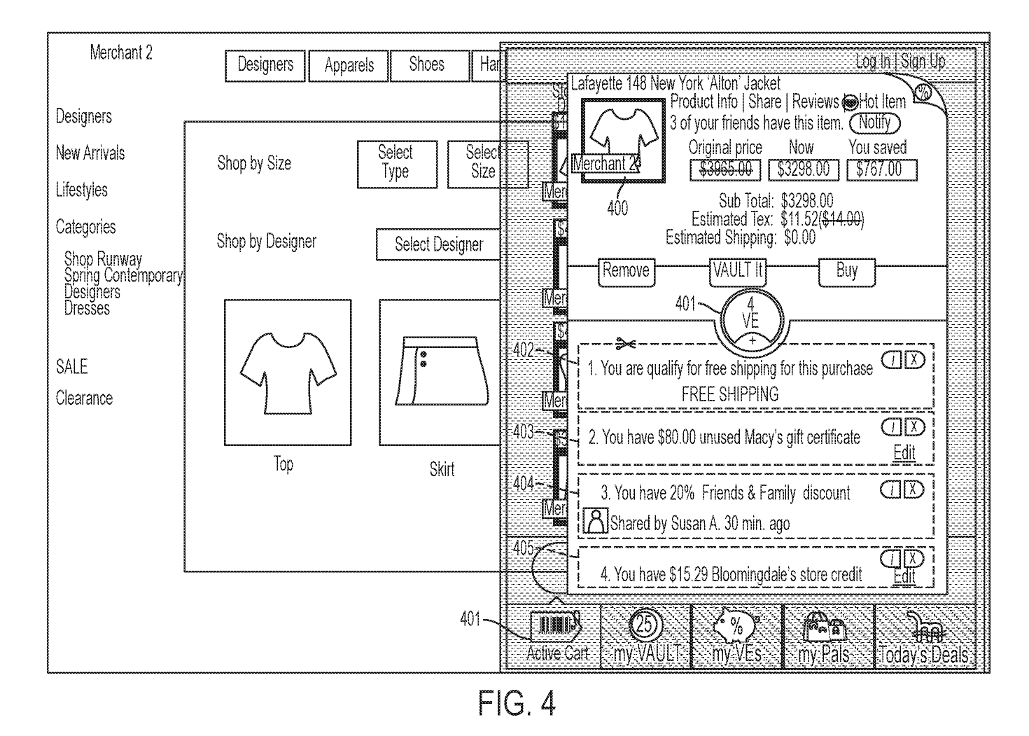

Referring to FIG. 4, upon selecting the designer shirt 400 in the system's shopping cart, the user can see all the available coupon 401: free shipping 402, gift certificate 403, friends and family discount 404, and a store credit 405.

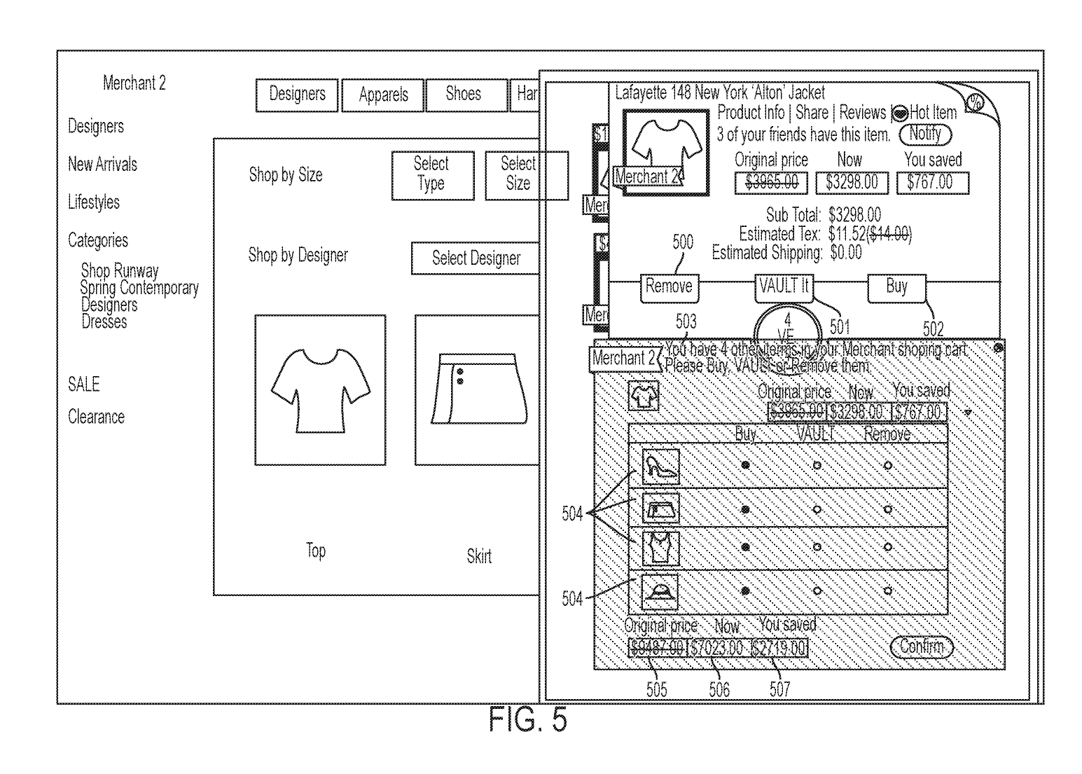

Referring to FIG. 5, within the system's shopping cart the user has several options regarding any particular product. The user may remove the item 500, place it in a wish list 501, referred to as a VAULT, or buy the item 502 from the cart. Upon selecting the option to buy the product 500, the system's shopping cart will provide a list of all items 503 in the user's cart from the same retailer. The user is then given overview of all the products 504 in the cart, the original total price 505, the current total price 506 after applying all the coupons, and the savings 507 to the user after optimization by the system.

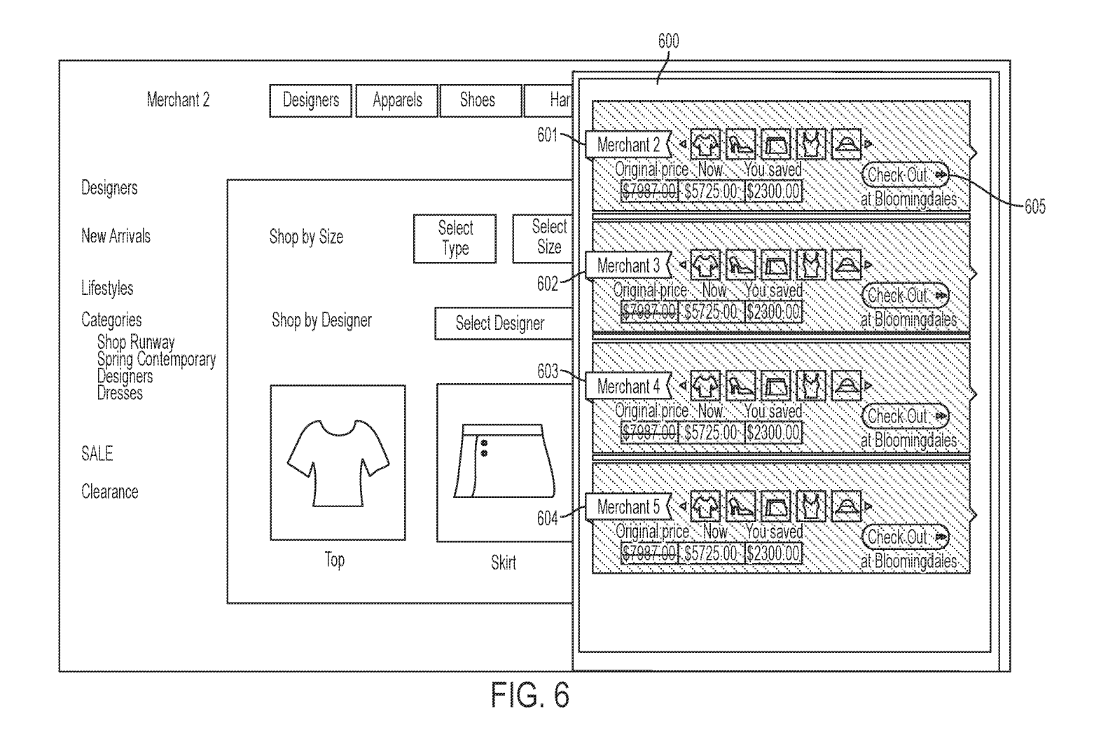

Referring to FIG. 6, selecting the preview and purchase option will take the user to a summary 600 of all the products in the various carts of the respective online retailers 601, 602, 603, 604. The user is able to see which retailer is the merchant and which items are in the carts of the respective retailers. Furthermore, the user is given an option to check out 605 via the system's shopping cart checkout process, which will complete the checkout for the user through the retailer's Web site.

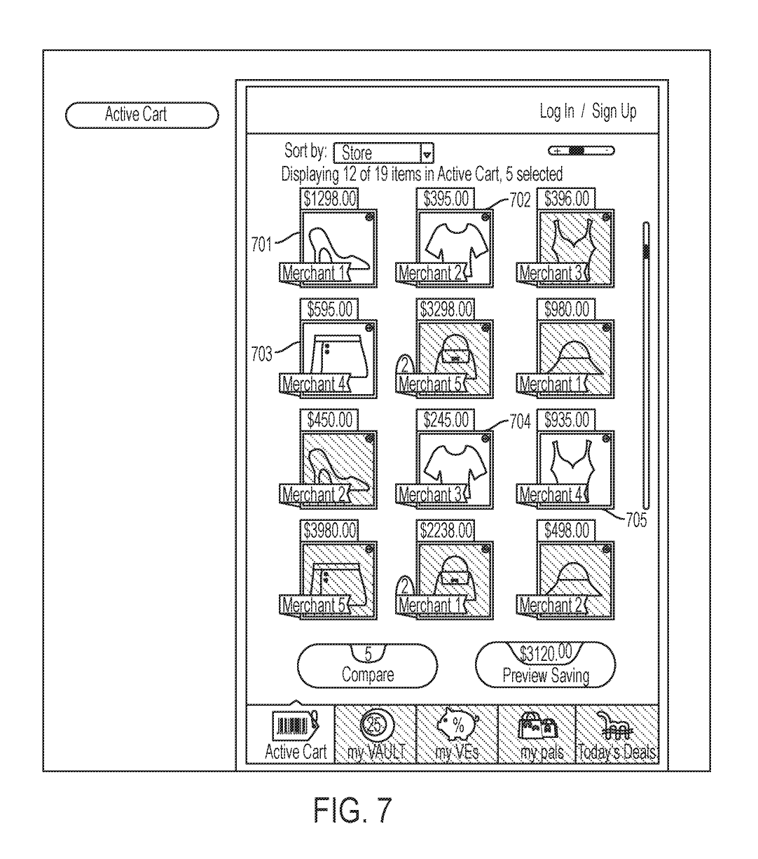

The shopping cart disclosed in the present invention herein can also improve the user's shopping experience via optimizing the user's shopping cart across different retailers involving multitude of different products. Referring to FIG. 7, the user selects five items 701, 702, 703, 704, 705 from various merchants from the multitude of products in the shopping cart of the various retailers.

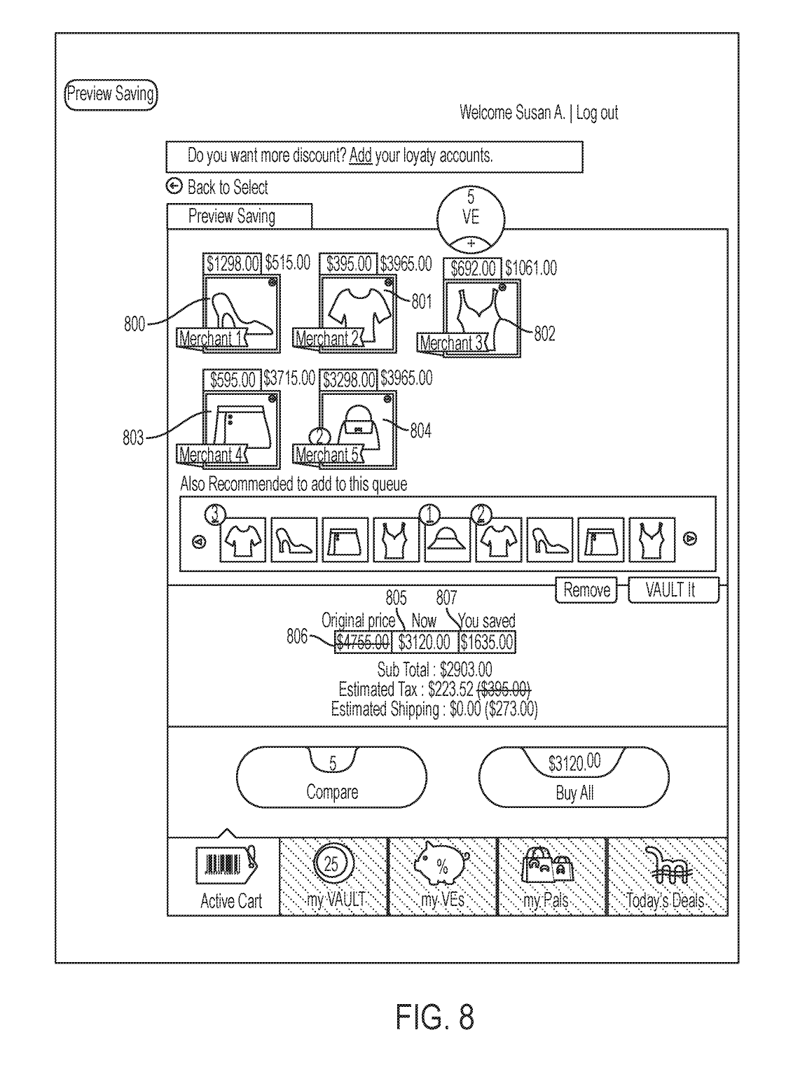

Referring to FIG. 8, upon selection of the five desired products for purchase, the system will apply all available coupons to each of the items 800, 801, 802, 803, 804. Each product may have a different type and number of coupons being applied to it, resulting in different discounts. The original purchase price 805, the current price 806 with coupons being applied, and the savings 807 for the user are also all displayed. Furthermore, the system is also able to suggest a potential coupon that is available and that the user may consider using upon the satisfaction of certain conditions.

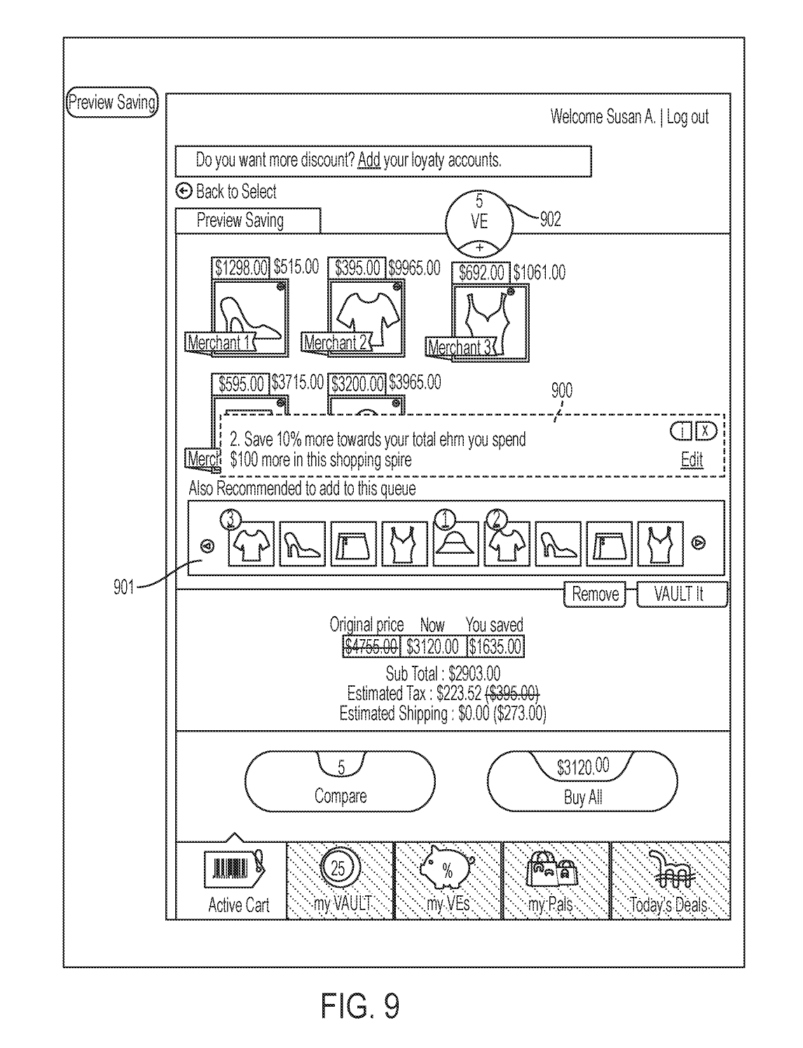

Referring to FIG. 9, the system recommends to the user a potential coupon 900 of 10% available to the user if the user can spend $100 more in the same shopping session with additional product(s). Furthermore, the system will also provide recommendations of potential products 901 that will satisfy the condition(s) of the suggested coupons and that are products that the user desires and would purchase. In this instance, five coupons 902 are applied to this current shopping trip.

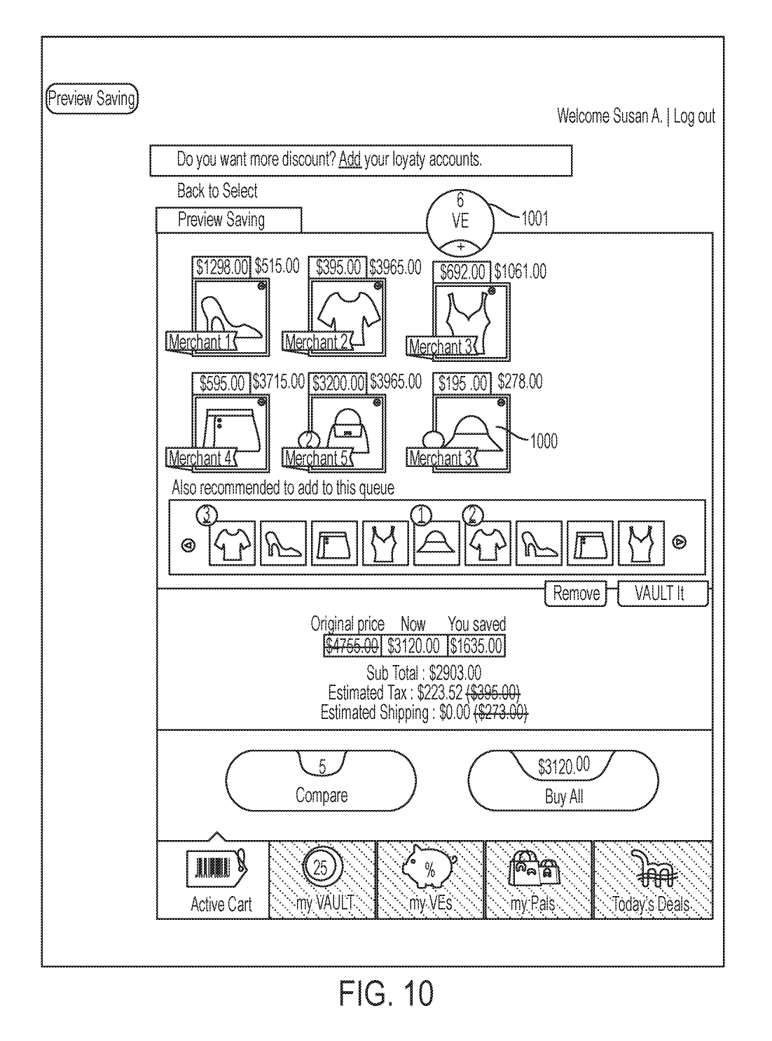

Referring to FIG. 10, upon the selection of one 1000 of the recommended products that both the user desires and that satisfies the conditions of the suggested coupon, the product 1000 is added to the cart and the suggested coupon is applied to the purchase, resulting in six coupons 1001 being applied to the shopping trip.

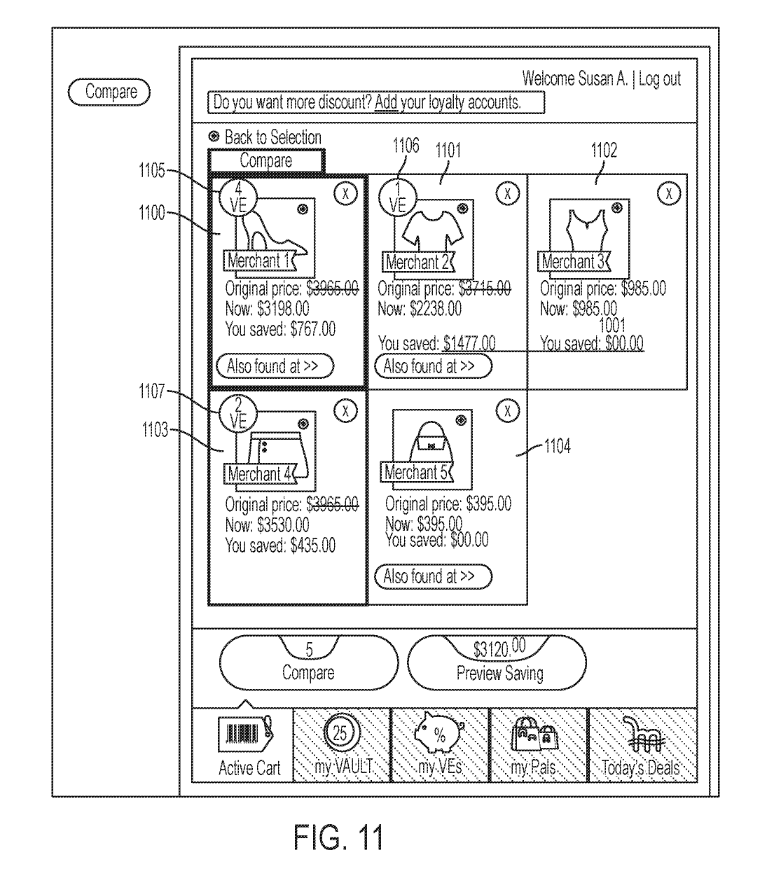

The present invention also allows the user to comparison shop across various retailers involving different products. Referring to FIG. 11, the user has chosen five products 1100, 1101, 1102, 1103, 1104 from a variety of retailers for consideration. The system's shopping cart can provide a quick overview of the various deals by showing the number of coupons 1105, 1106, 1107 applied to each product, the original price of each product, the current price of each product after applying the coupons, and the savings of each product. The overview of the products provided by the system's shopping cart are the best available prices for each of the products.

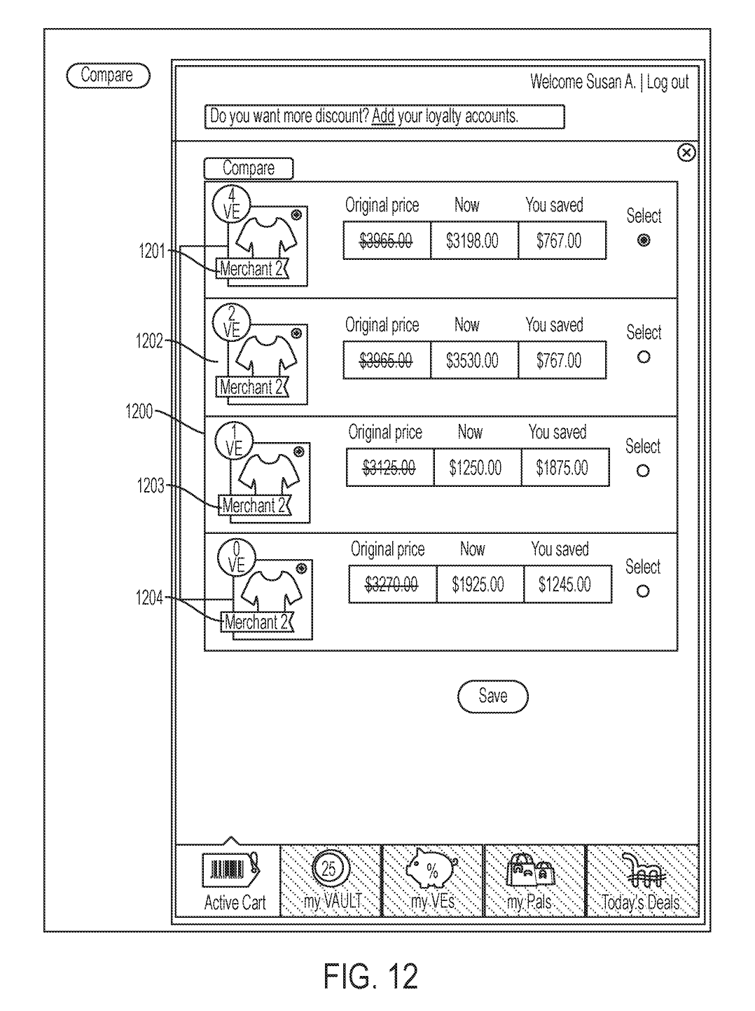

Referring to FIG. 12, clicking on the product allows the user to see a comparison of the same product 1200 available across the different retailers 1201, 1202, 1203, 1204 carrying the same product. The user is then able to make an informed decision regarding which retailer to buy which product given the available coupons.

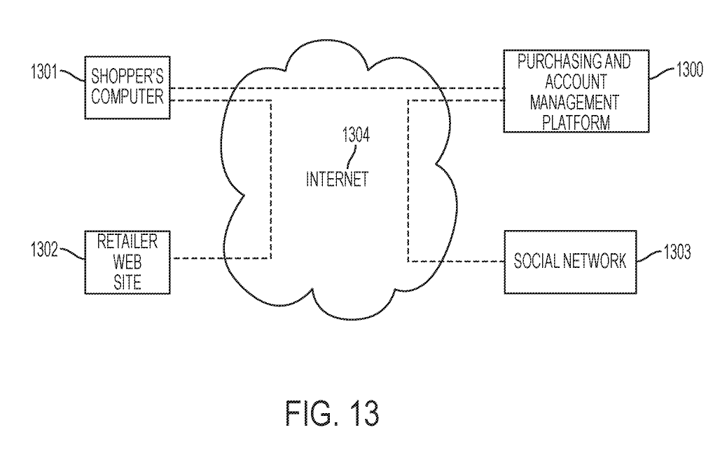

Referring to FIG. 13 is a schematic diagram illustrating the overview of the system 1300 in relation to the user via her computer 1301, the retailer via its Web site 1302, and the social networking component 1303 of e-commerce all connected via the internet 1304.

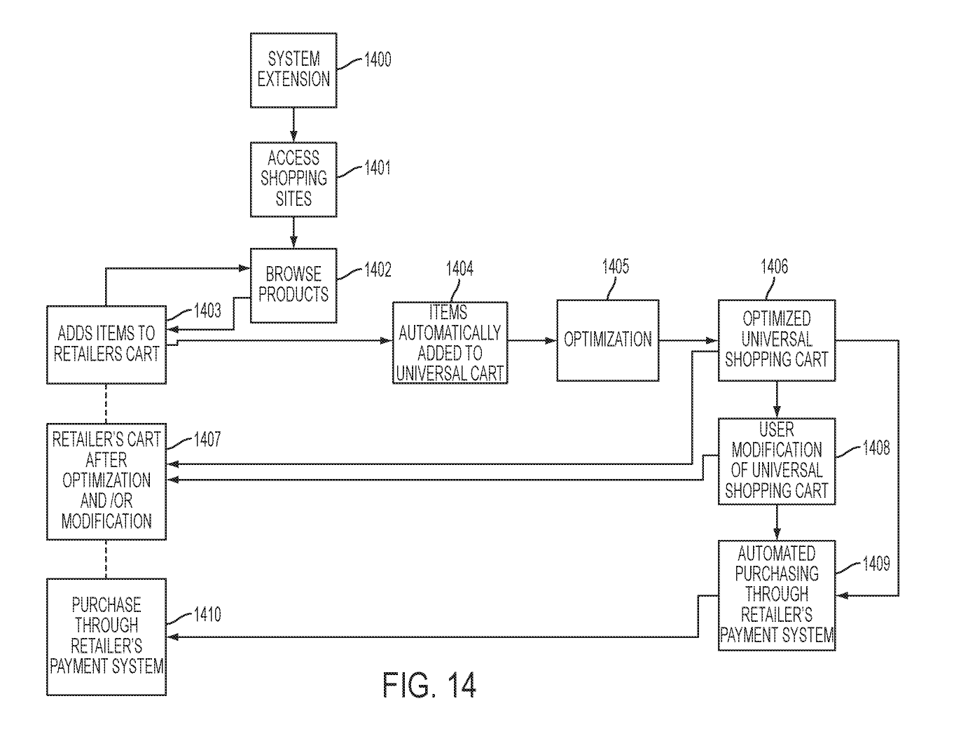

With reference to FIG. 14, this is a flowchart illustrating the user's experience shopping with retailers using the extension of the present invention disclosed herein. Initially, it is assumed that the user has downloaded and installed the plug-in extension 1401 for a particular browser, such as Internet Explorer, Mozilla Firefox, Google Chrome, Apple Safari, etc. The user then proceeds to a retailer's Web site 1401 and browse 1402 for desired items. Once the user has entered an item into the shopping cart of that site 1403, the plug-in extension automatically replicates that item into the system's universal shopping cart 1404. Every time the user adds an item into a merchant's shopping cart, the system automatically gives the user a snapshot of the item and the best value for the item from a particular merchant. In addition, the system may also provide the second and third runner-up merchants in terms of the total purchase price. Furthermore, the user can shop at other retailer's Web sites as well, and similarly, once the user adds an item into the respective retailer's shopping cart 1403, the system will automatically replicate that item in the system's universal shopping cart 1404. Next, upon proceeding to purchase, the system will perform an optimization process 1405, which takes into account multi-item discounts, coupons, rewards, loyalty programs or points, etc. Based on the user's actions within the universal shopping cart 1406, the retailer's shopping cart 1407 can be altered or modified accordingly. Within the universal shopping cart 1406, the user can choose to make modifications 1408 or proceed to check out via the system's automated checkout 1409. If the user makes modifications 1408 to the universal shopping cart, the modifications will also be reflected in the retailer's cart 1407. If the user proceeds to check out via the automated checkout 1409, this will cause the retailer's checkout 1410 to proceed to the end and allow the user to finish the transaction.

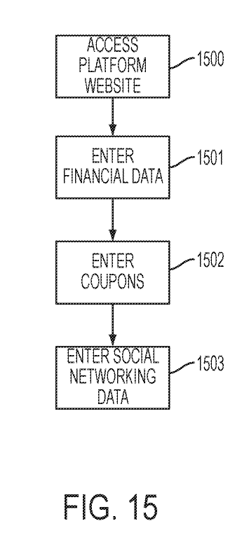

Referring to FIG. 15, this is a flowchart illustrating the data management component of the system described in the present invention disclosed herein. Initially, the user accesses the platform Web site 1500 such as a dashboard module. The user enters the section referring to credit card and other financial data section, and enters all financial data 1501 as she desires. Next, the user enters the coupon, rewards, and promotions section, and enters any coupons 1502 she desires. Finally, the user will be prompted to enter the appropriate data concerning social networking 1503.

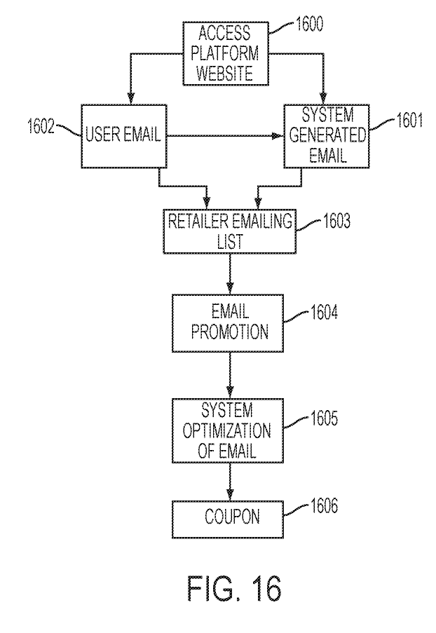

With reference to FIG. 16, this is a flowchart illustrating the system's email component (universal login module) of the present invention disclosed herein. More specifically, upon accessing the system's Web site 1600, the user may choose to obtain a system generated email 1601 or continue to use her own email 1602 for all future correspondence with retailers. Then, the selected email address will be used by the retailer and be placed on an emailing list 1603. Upon the retailer's sending targeted promotions 1604 to selected consumers, the coupons will be automatically aggregated and organized 1605 for the user. The user is then able to view the full promotion sent to the user as well as view all active offers or coupons by the merchant 1606 through the system.

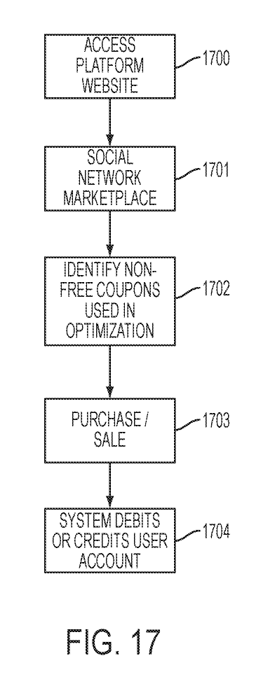

Referring to FIG. 17, this is a flowchart illustrating the acquisition of promotions or coupons from a social network marketplace. Initially, the user access the system's Web site 1700, and enters into the social network marketplace section 1701. The user will be presented will all promotions available for sale or trade 1702, as the system will automatically take into account the one freely available. The user is then able to purchase or sell any coupon 1703 she desires by either assigning a value to the coupon or let the system automatically assign a value for her. Upon any purchase or sale of these coupons 1703, the system will automatically debit or credit the user's account 1704 accordingly.

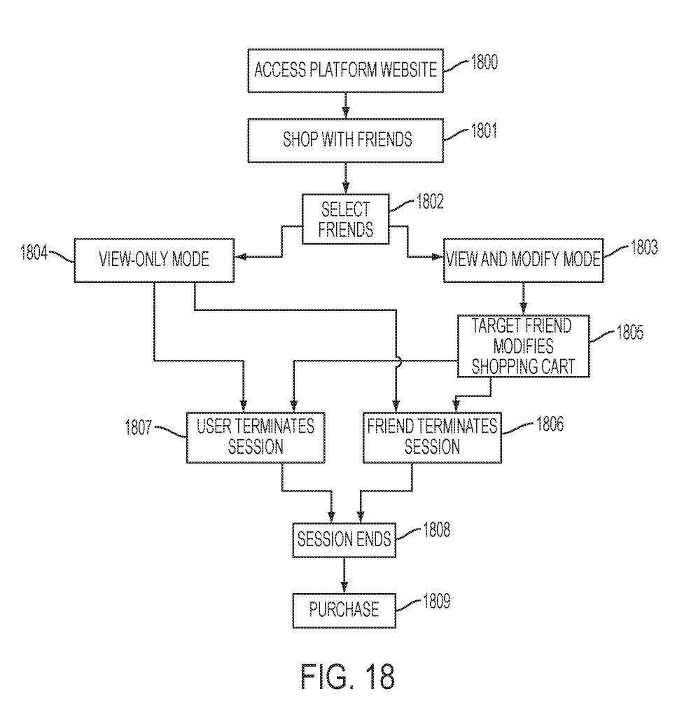

Referring to FIG. 18 is a social shopping experience component (shop with a friend module) of the system as disclosed by the present invention. Initially, the user accesses the system's Web site 1800, and search for friends to shop with her 1801. The user can enter the email address 1802 of the person with whom she wants to share her shopping experience. If the friend is already a registered client, the system will verify by displaying the person's name. If the friend is not a registered client, then the system will proceed to send an invitation to the friend, requesting that the friend register with the system while indicating the person inviting her. The user has the option of allowing the friend to participate in the shopping experience through the view-and-modify mode 1803 or to limit the friend's participation to view-only mode 1804. In the view-and-modify mode 1803, the friend would have the ability to modify the user's shopping cart 1805, whereas in the view-only mode 1804, the friend cannot make any modifications to the user's shopping cart. The session can terminate either when the friend terminates the session 1806 or the user terminates the session 1807. Either method will terminate the user's shopping session with her friend 1808, and the user has the option to proceed to purchase the items 1809.

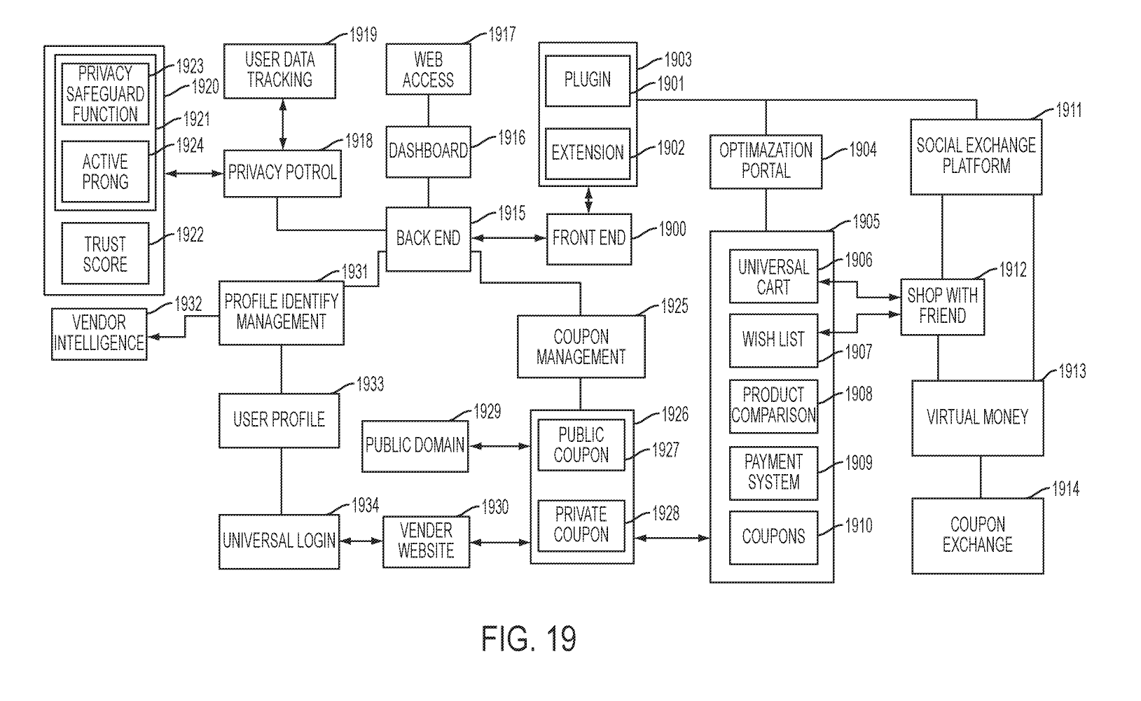

Referring to FIG. 19, this is an overview of the online purchasing and account management system. More specifically, on the front end 1900, the user can download and install as a plug in 1901 that will provide an extension 1902 of the system on the user's computer 1903. The user, via the optimization portal 1904, is then able to access an optimization system 1905. The optimization system comprises of a universal cart module 1906, a wish list module 1907, a product comparison module 1908, a payment system module 1909, and a coupons application module 1910. Via the user's computer 1903, the user is also able to access the social exchange platform module 1911, which allows the user to shop with friends through shop with friend module 1912 or use virtual money 1913 in connection with the sale or purchase of coupons 1914. In the shop with friend module 1912, at the option of the user, the friend may be able to access the universal shopping cart module 1906 and/or the wish list module 1907 of the user. With the coupon exchange module 1914, the coupons 1910 obtained via the exchange may be used by the optimization system 1905.

Also referring to FIG. 19, on the back end 1915, the user, via the dash board 1916, can access the web site of the system 1917. Furthermore, on the back end 1915 is also a privacy patrol module 1918 that tracks user data 1919. Also as part of the privacy patrol 1918 is a security and privacy system 1920 comprising of a user security module 1921 and a trust score module 1922. The user security module 1921 comprises of a privacy safeguard function 1923, which accesses the likelihood whether a retailer is leaking user data to others, and an active prong 1924, which allows the system to release “realistic but fake” data records to further improve the chances of detecting leakage and identifying the retailer that is responsible for comprising user data. Furthermore, the trust score component 1922 of the security and privacy system 1920 provides the user with a score indicating the trustworthiness of a particular web site.

Also referring to FIG. 19, on the back end 1915, the user also has access to a coupon management module 1925, wherein she can access all available coupons 1926 which is made up of public coupons 1927 and private coupons 1928. The public coupons 1927 are coupons retrieved from the public domain 1929, whereas the private coupons 1928 are coupons targeted by the merchant at the user such as through the merchant's web site or email list 1930.

Finally, also referring to FIG. 19, on the back end 1915, the user has access to profile and identity management module 1931, which can provide merchants with user data intelligence 1932. Via the profile and identity management module 1931, the user can also access her user profile 1933, which gives her access to a universal login 1934. Via this universal login 1934, the user can control her information on the merchant's web site 1930, and thus control the private coupons 1928 that she receives.

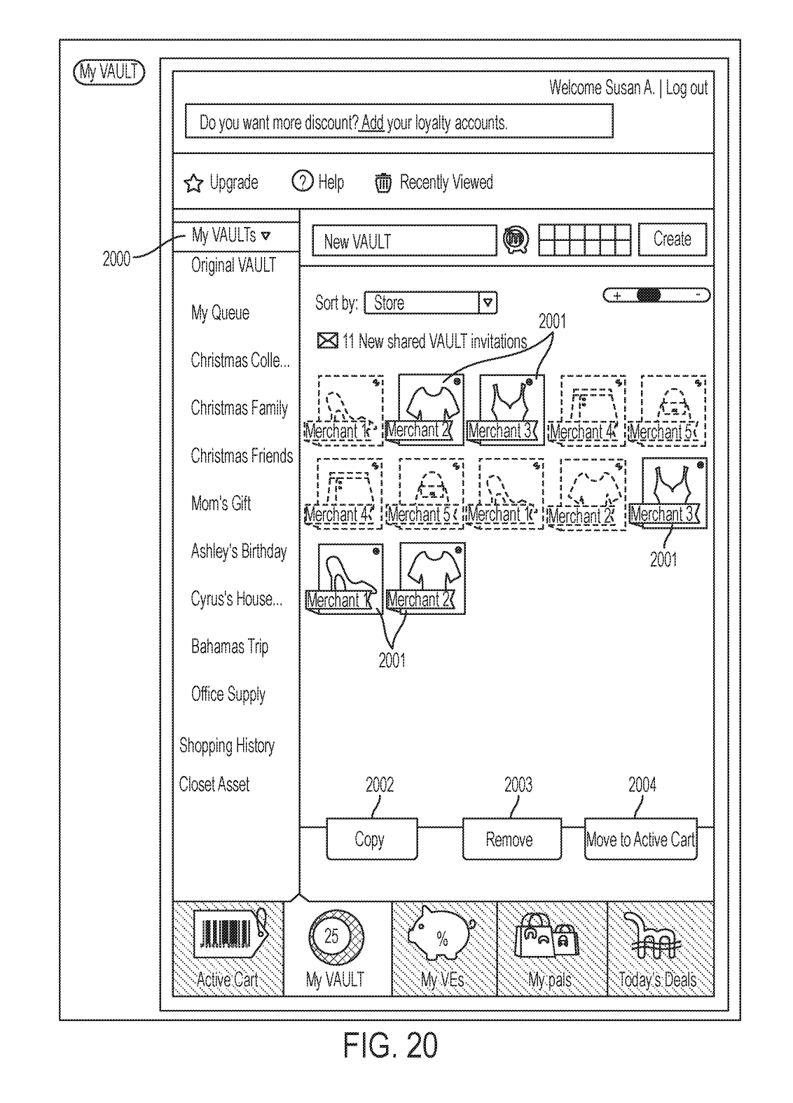

Referring to FIG. 20, the user may sign in and gain access to her VAULT 2000. The items in the VAULT are identified by individual tiles, and users can select one or more tiles 2001 from the list by clicking on the tiles 2001. Then, the user has the options of copying the items by clicking “copy” 2002, removing the items by clicking “remove” 2003, or moving the items to active cart by clicking “move to active cart” 2004.

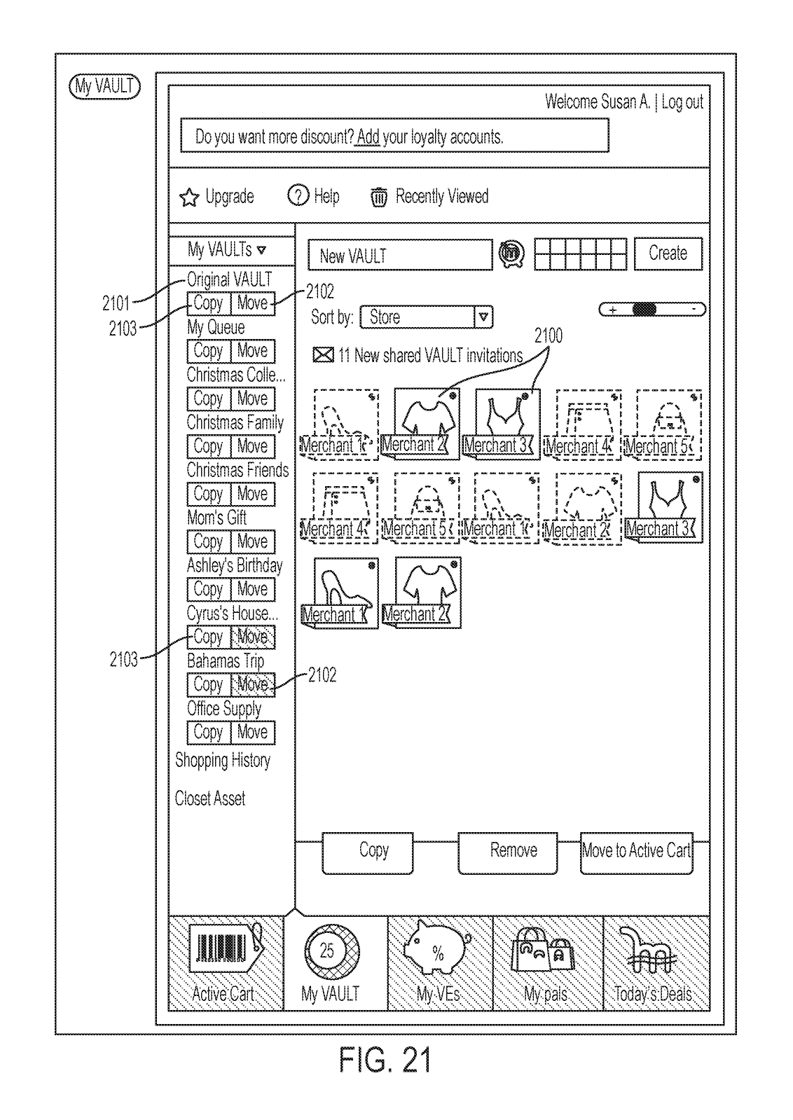

Referring to FIG. 21, upon selection of the desired items by clicking on the item tiles 2100, the user can move the selected items by holding the mouse click and dragging the tiles 2100. Upon dragging the tiles 2100, under each of the custom VAULTs 2101 will appear two icons. One icon named “move” 2101 allows the user to move the items represented by the selected tiles 2100 to the respective custom VAULT. This “move” function allows the items represented by the tiles 2100 to be deleted from the general VAULT and added to the respective custom VAULT. The other icon named “copy” 2103 allows the user to copy the items represented by the selected tiles 2100 to the respective custom VAULT. This “copy” function ensures that the items are copied to the custom VAULT without deleting the tiles from the general VAULT.

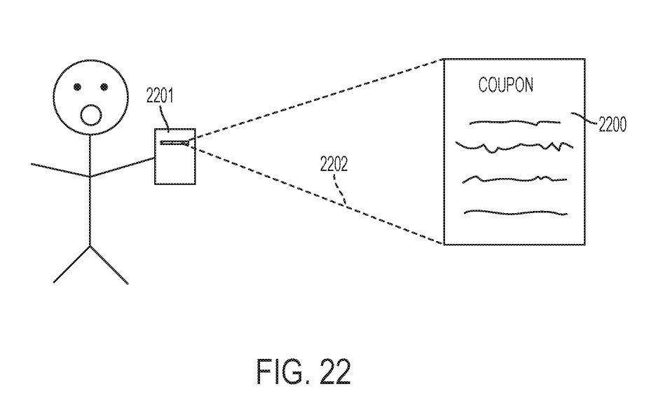

Referring to FIG. 22, the user received a physical coupon 2200, upon which the user can use a smart phone or similar mobile device 2201 and scan 2202 the coupon code to be stored into an online database that is accessible to the user at a later time.

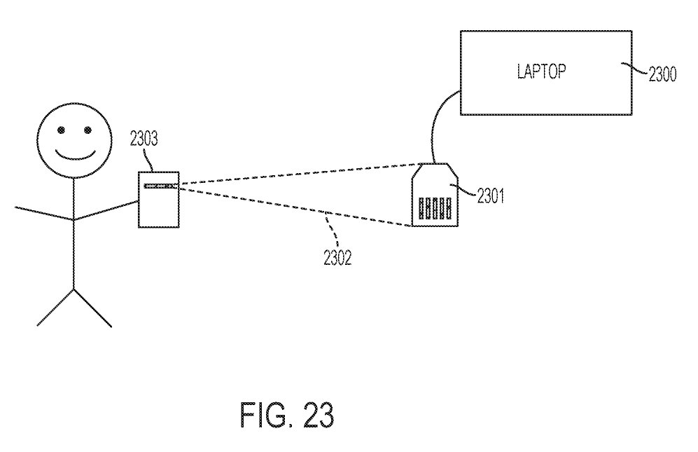

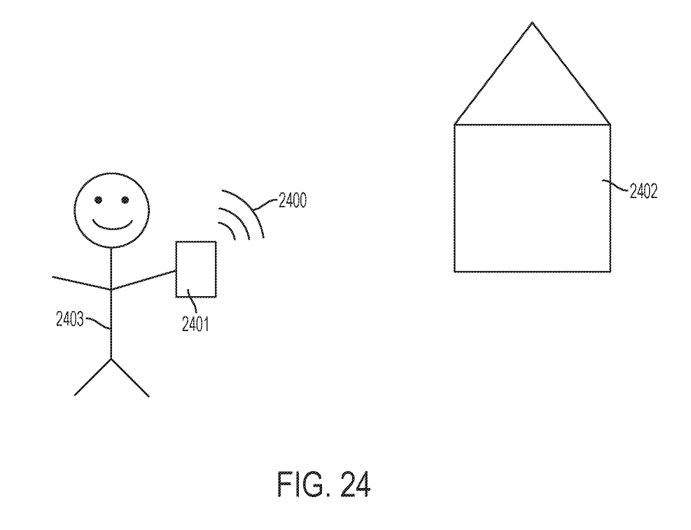

Furthermore, referring to FIG. 23, the user can also add an item 2300 found in a physical store by scanning 2302 the barcode of the item 2300 via a smart phone or similar device 2303. Finally, referring to FIG. 24, the mobile application with the use of location detection 2400 on the smart phone or mobile device 2401 can detect the location of the user and the available retail stores 2402 nearby. Upon detecting the available stores 2402, the mobile App is able to provide the user with a list of coupons available for use at the retail store 2402.

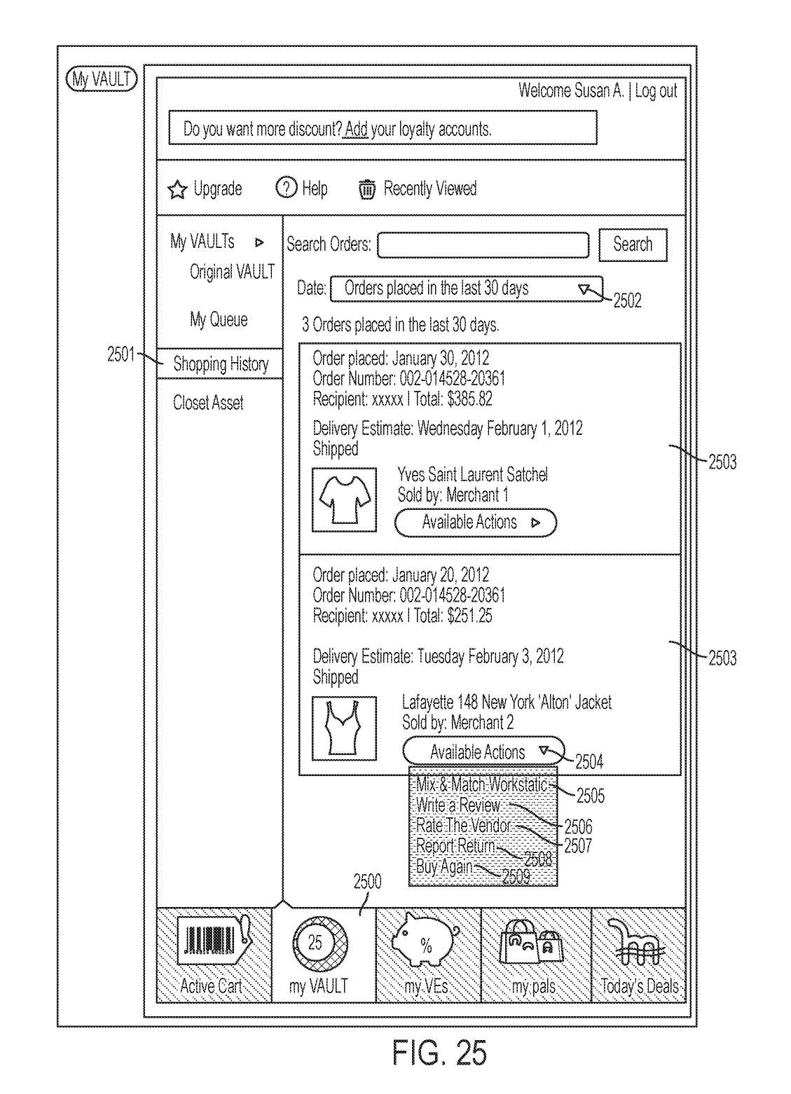

Referring to FIG. 25, under the user's vault 2500, the user has access to her shopping history 2501, wherein she can view items she has previously purchased. The user is able to set the date range 2502 of when the items were purchased, and the system will display a list of items 2503 purchased within the set dates. Furthermore, for each item in the inventory, the user has several options 2504: the user can select the mix and match workstation 2505; the user can write a review 2506; the user can rate the vendor 2507; the user can report returning the item 2508; and the can also buy the item again 2509.

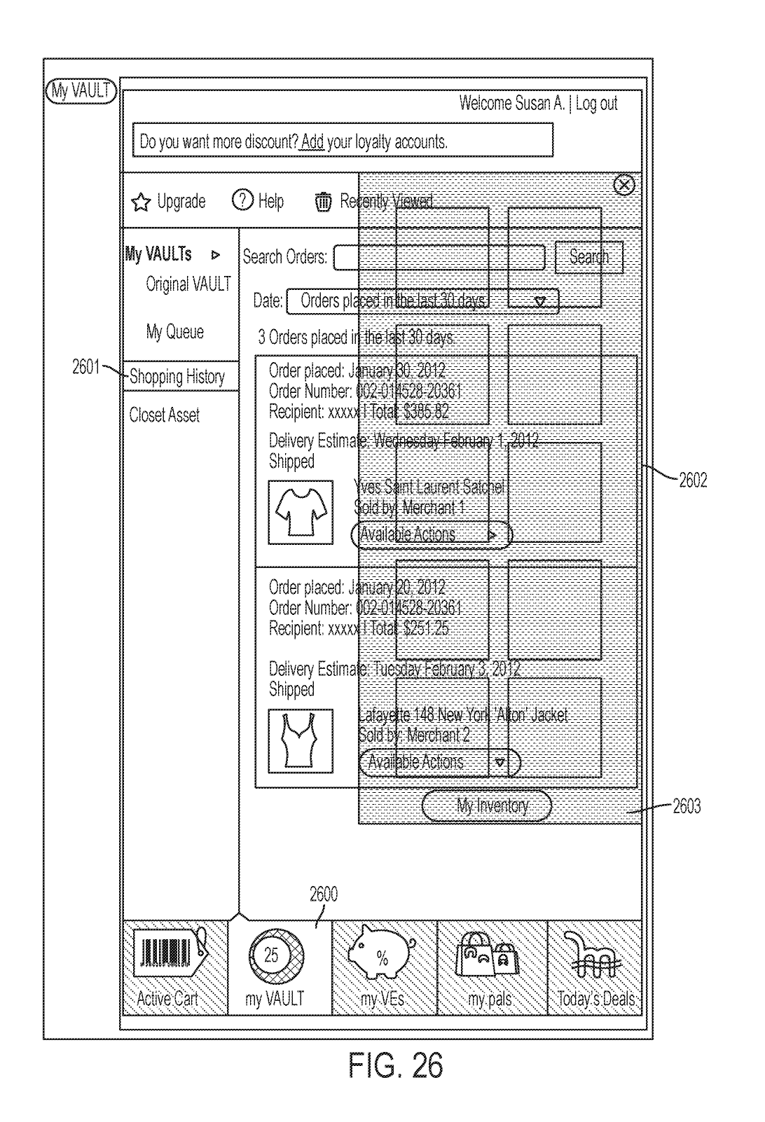

Referring to FIG. 26, in the user's vault 2600 and under shopping history 2601, upon the user's selection of the mix and match function, the workstation 2602 will be activated, wherein there are tiles 2603 into which users may place items.

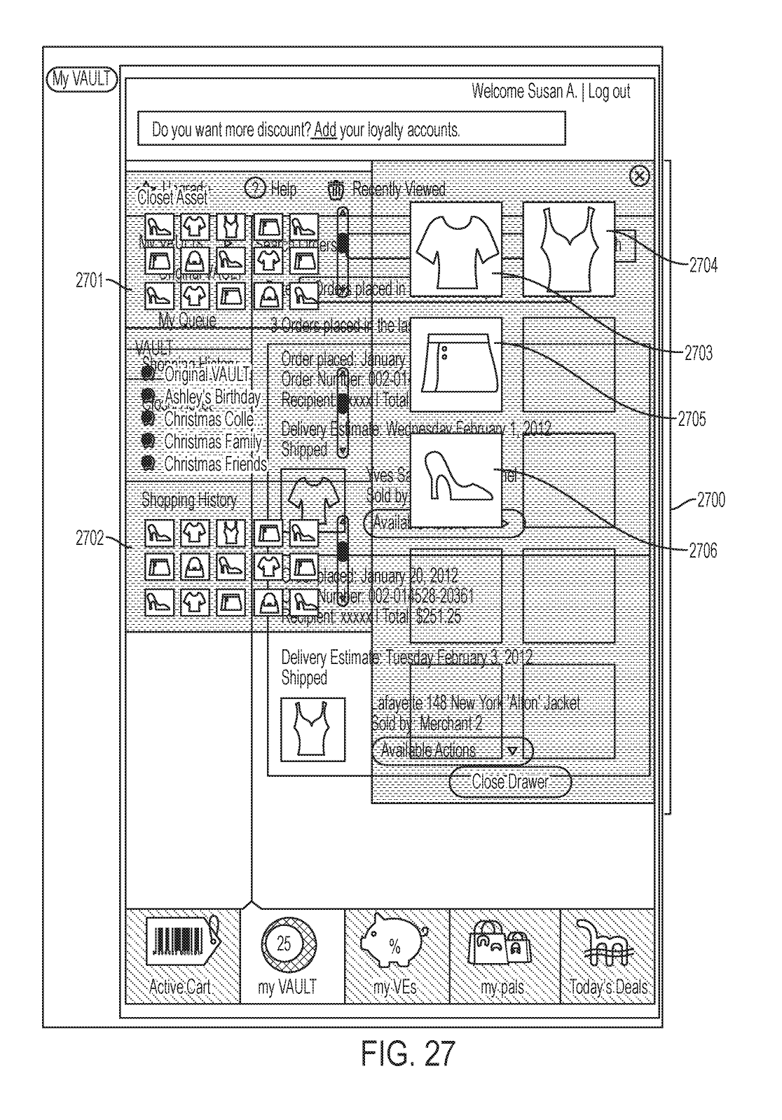

Referring to FIG. 27, in the work station 2700, the user can choose from items that the user is contemplating purchasing 2701 or from the items that the user has already purchased 2702. In the workstation 2700, the user has already placed several items into the tiles: a shirt 2703, a tank top 2704, a shirt 2705, and a pairs of high heels 2706.

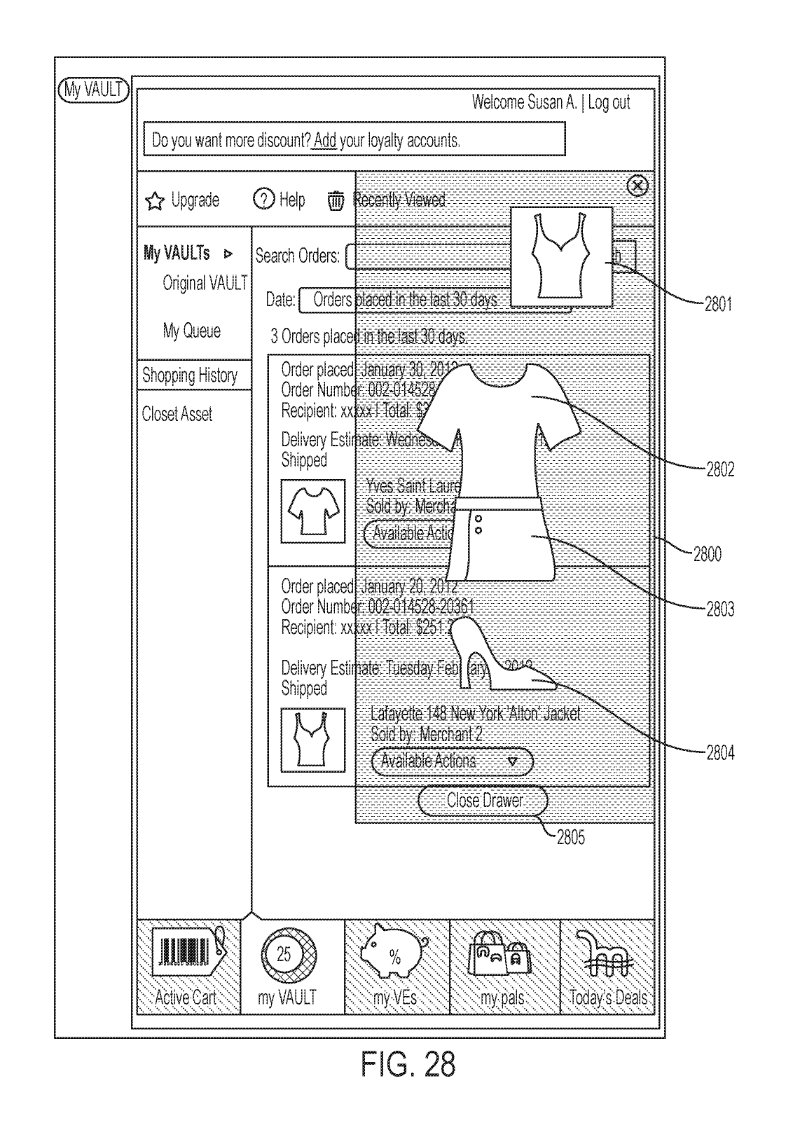

Referring to FIG. 28, in the workstation 2800 are now the items 2801, 2802, 2803, 2804 that were previously placed into tiles. In the workstation 2800, the user can mix and match her clothes, and see which of the new items she desires to purchase complements her existing wardrobe.

What is claimed:

1-39. (canceled)

40. A system for comparison shopping and optimizing discounts for a plurality of merchants, the system comprising:
a processing device; and
a non-transitory, computer-readable storage medium in operable communication with the processing device, wherein the non-transitory, computer-readable storage medium contains one or more programming instructions that, when executed, cause the processing device to:
receive a selection of a product from a user via a user computing device, locate a plurality of comparison products comprising the product as available for purchase at a plurality of merchant websites of the plurality of merchants responsive to receiving the selection,
determine a maximized discount for each of the plurality of comparison products, the maximized discount being determined by applying a plurality of available discounts, the plurality of available discounts comprising public discounts, private discounts, shared discounts, and shipping discounts,
cause a presentation of the plurality of comparison products on a comparison shopping interface via a display device of a user computing device, the comparison shopping interface presenting, for each of the plurality of comparison products, a current price of the product, a discounted price after applying the maximized discount, and a total savings,
receive, from the user computing device, an option to purchase selection for at least one of the plurality of comparison products, and
facilitate a checkout process with a merchant website of the plurality of merchant websites associated with the option to purchase selection at the discounted price.

41. The system of claim 40, wherein the one or more programming instructions, when executed, further cause the processing device to determine the maximized discount by applying dollar amount spending threshold discounts.

42. The system of claim 40, wherein the one or more programming instructions, when executed, further cause the processing device to determine the maximized discount by prioritizing discounts based on expiration date.

43. The system of claim 40, wherein the one or more programming instructions, when executed, further cause the processing device to determine the maximized discount by iteratively applying each of the plurality of available discounts to generate a plurality of discounted prices for the product for each of the plurality of merchant websites by applying different combinations of the plurality of available discounts.

44. The system of claim 40, wherein the one or more programming instructions, when executed, further cause the processing device to determine the maximized discount by creating a shopping cart for the product on f the plurality of merchant web sites.

45. The system of claim 40, wherein the one or more programming instructions, when executed, further cause the processing device to present a potential coupon on a display of the user computing device, the potential coupon being active based on a potential condition.

46. The system of claim 45, wherein the potential condition comprises spending over a threshold amount.

47. The system of claim 45, wherein the potential condition comprises a purchase of potential products satisfying the potential condition.

48. The system of claim 47, wherein the one or more programming instructions, when executed by the processor, further cause the processor to recommend at least some of the potential products.

49. The system of claim 40, wherein the one or more programming instructions, when executed by the processor, further cause the processor to generate a user-centric universal shopping cart for the user, the universal shopping cart being configured to replicate a plurality of merchant shopping carts in a single location, each of the plurality of merchant shopping carts being accessible from one of a plurality of web sites of a plurality of merchants.

50. The system of claim 49, wherein the one or more programming instructions, when executed by the processor, further cause the processor to:
receive, from the user computing device, one or more items to be purchased from the plurality of merchant web sites responsive to the user placing the one or more items to be purchased in at least one of the plurality of merchant shopping carts, and replicate the one or more items to be purchased in the universal shopping cart.

51. The system of claim 49, wherein the one or more programming instructions, when executed, further cause the processing device to receive a product selection of a product in the universal shopping cart from the user computing device, wherein the plurality of comparison products are located responsive to the product selection.

52. A computer-readable storage medium having computer-readable program code configured to facilitate comparison shopping and optimizing discounts for a plurality of merchants, the computer-readable program code comprising:
computer-readable program code configured to receive a selection of a product from a user via a user computing device;
computer-readable program code configured to locate a plurality of comparison products comprising the product as available for purchase at a plurality of merchant websites of the plurality of merchants responsive to receiving the selection;
computer-readable program code configured to determine a maximized discount for each of the plurality of comparison products, the maximized discount being determined by applying a plurality of available discounts, the plurality of available discounts comprising public discounts, private discounts, shared discounts, and shipping discounts;
computer-readable program code configured to present the plurality of comparison products on a comparison shopping interface via a display device of a user computing device, the comparison shopping interface presenting, for each of the plurality of comparison products, a current price of the product, a discounted price after applying the maximized discount, and a total savings;
computer-readable program code configured to receive, from the user computing device, an option to purchase selection for at least one of the plurality of comparison products; and
computer-readable program code configured to facilitate a checkout process with a merchant website of the plurality of merchant websites associated with the option to purchase selection at the discounted price.

53. The computer-readable storage medium of claim 52, wherein the computer-readable program code configured to determine the maximized threshold is further configured to determine the maximized discount by applying dollar amount spending threshold discounts.

54. The computer-readable storage medium of claim 52, wherein the computer-readable program code configured to determine the maximized threshold is further configured to determine the maximized discount by prioritizing discounts based on expiration date.

54. The computer-readable storage medium of claim 52, wherein the computer-readable program code configured to determine the maximized threshold is further configured to determine the maximized discount by iteratively applying each of the plurality of available discounts to generate a plurality of discounted prices for the product for each of the plurality of merchant websites by applying different combinations of the plurality of available discounts.

56. The computer-readable storage medium of claim 52, wherein the computer-readable program code configured to determine the maximized threshold is further configured to determine the maximized discount by creating a shopping cart for the product on the plurality of merchant web sites.

57. The computer-readable storage medium of claim 52, further comprising:
computer-readable program code configured to present a potential coupon on a display of the user computing device, the potential coupon being active based on a potential condition.

58. The computer-readable storage medium of claim 57, wherein the potential condition comprises spending over a threshold amount.

59. The computer-readable storage medium of claim 57, wherein the potential condition comprises a purchase of potential products satisfying the potential condition.

60. The computer-readable storage medium of claim 59, further comprising:
computer-readable program code configured to recommend at least some of the potential products.

61. The computer-readable storage medium of claim 52, further comprising:
computer-readable program code configured to generate a user-centric universal shopping cart for the user, the universal shopping cart being configured to replicate a plurality of merchant shopping carts in a single location, each of the plurality of merchant shopping carts being accessible from one of a plurality of web sites of a plurality of merchants.

62. The computer-readable storage medium of claim 61, further comprising:
computer-readable program code configured to receive, from the user computing device, one or more items to be purchased from the plurality of merchant websites responsive to the user placing the one or more items to be purchased in at least one of the plurality of merchant shopping carts; and
computer-readable program code configured to replicate the one or more items to be purchased in the universal shopping cart.

63. The computer-readable storage medium of claim 61, further comprising:
computer-readable program code configured to receive a product selection of a product in the universal shopping cart from the user computing device, wherein the plurality of comparison products are located responsive to product selection.
